(19) United States
(12) Patent Application Publication
(10) Pub. No.: US 2018/0352209 A1
(43) Pub. Date: Dec. 6, 2018

(54) Methods and Systems for Light Field Compression Using Multiple Reference Depth Image-Based Rendering

(71) Applicant: Ostendo Technologies, Inc., Carlsbad, CA (US)

(72) Inventors: Wankai Liu, Nanping, Fujian (CN); Zahir Y. Alpaslan, San Marcos, CA (US); Hussein S. El-Ghoroury, Carlsbad, CA (US)

(21) Appl. No.: 15/993,268

(22) Filed: May 30, 2018

Related U.S. Application Data
(60) Provisional application No. 62/514,294, filed on Jun. 2, 2017.

(51) Int. Cl. H04N 13/122; G06T 15/00; G06T 5/50; H04N 13/156; H04N 13/271

(52) U.S. Cl. CPC H04N 13/122; G06T 15/00; G06T 5/50; G06T 2207/20221; H04N 13/271; G06T 2207/10052; H04N 13/156

(57) ABSTRACT

Methods and systems for compression of light field images using Multiple Reference Depth Image-Based Rendering techniques (MR-DIBR) are disclosed. The methods and systems enhance light field image quality of compressed light field images using reference depth (or disparity) and color maps to enable hole filling and crack filling in compressed light field image data sets.

### CROSS REFERENCE TO RELATED APPLICATIONS

This application claims the benefit of U.S. Provisional Application No. 62/514,294 filed on Jun. 2, 2017, the disclosure of which is incorporated by reference herein.

### FIELD OF THE INVENTION

Embodiments of the invention relate to light field display compression. More specifically, embodiments of the invention relate to Multiple Reference Depth Image-Based Rendering (MR-DIBR) that enables the compression of light field images using reference depth (or disparity) and color maps.

### BACKGROUND

Light field image data compression has become a necessity to accommodate the large amounts of image data associated with full parallax and full color light field displays that generally comprise millions of elemental images. Conventional light field compression methods using depth image-based rendering (DIBR), while efficient for compression of elemental images, may be unable to incorporate occlusion and hole-filling functions necessary to provide high quality light field images at acceptable compression ratios. An example of such conventional DIBR compression method is disclosed in, for instance, U.S. Patent Application Publication No. 2016/0360177 entitled, “Methods for Full Parallax Compressed Light Field Synthesis Utilizing Depth Information”, the disclosure of which is incorporated herein by reference.

Light field displays modulate the light's intensity and direction for reconstructing three-dimensional (3D) objects in a scene without requiring specialized glasses for viewing. In order to accomplish this, light field displays typically utilize a large number of views, which imposes several challenges in the acquisition and transmission stages of the 3D processing chain. Compression is a necessary tool to cope with the huge data sizes involved and it is common that systems sub-sample views at the image generation stage and then reconstruct the absent views at the display stage. For example, in Yan et al., “Integral image compression based on optical characteristics,” Computer Vision, IET, vol. 5, no. 3, pp. 164, 168 (May 2011) and Yan Piao et al., “Sub-sampling elemental images for integral imaging compression,” 2010 International Conference on Audio Language and Image Processing (ICALIP), pp. 1164, 1168 (23-25 Nov. 2010), the authors perform sub-sampling of elemental images based on the optical characteristics of the display system. A more formal approach to light field sampling is found in the works of Jin-Xiang Chai et al., (2000) “Plenoptic sampling”, in Proceedings of the 27th annual conference on Computer graphics and interactive techniques (SIGGRAPH '00) and Gilliam, C. et al., “Adaptive plenoptic sampling”, 2011 18th IEEE International Conference on Image Processing (ICIP), pp. 2581, 2584 (11-14 Sep. 2011). In order to reconstruct the light field views at the display side, several different methods are currently used ranging from computer graphics methods to image-based rendering methods.

In computer graphics methods, the act of creating a scene or a view of a scene is known as “view rendering”. In computer graphics, typically a complex 3D geometrical model incorporating lighting and surface properties from the camera point of view is used. This view rendering approach generally requires multiple complex operations and a detailed knowledge of the scene geometry.

Alternatively, Image-Based Rendering (IBR) replaces the use of complex 3D geometrical models with the use of multiple surrounding viewpoints used to synthesize views directly from input images that oversample the light field. Although IBR generates more realistic views, it requires a more intensive data acquisition process, data storage, and redundancy in the light field. To reduce the data handling penalty, Depth Image-Based Rendering (DIBR) utilizes depth information from the 3D geometrical model in order to reduce the number of required IBR views. (See, e.g., U.S. Pat. No. 8,284,237, and C. Fehn, “3D-TV Using Depth-Image-Based Rendering (DIBR),” in Proceedings of Picture Coding Symposium, San Francisco, Calif., USA, December 2004). In this approach, each view has a depth associated with each pixel position, known as a depth map, which depth map is then used to synthesize the absent views.

DIBR methods typically have three distinct steps: namely, 1) view warping (or view projection), 2) view merging, and 3) hole filling. View warping is the reprojection of a scene captured by one camera to the image plane of another camera. This process utilizes the geometry of the scene, provided by the per-pixel depth information within the reference view, and the characteristics of the capturing device, i.e., the intrinsic (e.g., focal length, principal point) and extrinsic (e.g., rotation, 3D position) parameters of the camera (C. Fehn, “3D-TV Using Depth-Image-Based Rendering (DIBR),” in Proceedings of Picture Coding Symposium, San Francisco, Calif., USA, December 2004). The view warping/view projection step may be performed in two separate stages: a forward warping stage that projects only the disparity values, and a backward warping stage that fetches the color value from the references. Since disparity warping can be affected by rounding and depth quantization, an optional disparity filtering block may be added to the system to correct erroneous warped disparity values.

After one reference view is warped, parts of the target image may still be unknown. Since objects at different depths move with different apparent speeds, part of the scene hidden by one object in the reference view may be disoccluded in the target view, while the color information of this part of the target view is not available from the reference. Typically, multiple references are used to try to cover the scene from multiple viewpoints so that disoccluded parts of one reference can be obtained from another reference image. With multiple views, not only the disoccluded parts of the scene can come from different references, but also parts of the scene can be visualized by multiple references at the same time. Hence, the warped views of the references may be complementary and overlapping at the same time.

View merging is the operation of bringing the multiple views together into one single view. If pixels from different views are mapped to the same position, the depth value is used to determine the dominant view, which will be given by either the closest view or an interpolation of several views.

Even with multiple views, the possibility exists that part of the scene visualized at the target view has no correspondence to any color information in the reference views. Those positions lacking color information are referred to as “holes”, and several hole-filling methods have been proposed to fill such holes with color information from surrounding pixel values. Usually holes are generated from object disocclusion and the missing color is correlated to the background color. Several methods to fill in holes according to background color information have been proposed (e.g., Kwan-Jung Oh et al., “Hole filling method using depth based in-painting for view synthesis in free viewpoint television and 3-D video,” Picture Coding Symposium, 2009. PCS 2009, pp. 1, 4, 6-8, May 2009).

Due to resolution limitations of the display device, DIBR methods have not been fully satisfactorily applied to full parallax light field images. However, with the advent of high resolution display devices having very small pixel pitches (for example, U.S. Pat. No. 8,567,960), view synthesis of full parallax light fields using DIBR techniques is now feasible.

In Levoy et al., light ray interpolation between two parallel planes is utilized to capture a light field and reconstruct its view points (See, e.g., Marc Levoy et al., (1996) “Light field rendering” in Proceedings of the 23rd annual conference on Computer graphics and interactive techniques (SIGGRAPH '96)). However, to achieve realistic results, this approach requires huge amounts of data be generated and processed. If the geometry of the scene, specifically depth, is taken into account, then a significant reduction in data generation and processing can be realized.

In Steven J. Gortler et al., (1996) “The lumigraph” in Proceedings of the 23rd annual conference on Computer graphics and interactive techniques (SIGGRAPH '96), the authors propose the use of depth to correct the ray interpolation, and in Jin-Xiang Chai et al., (2000) “Plenoptic sampling” in Proceedings of the 27th annual conference on Computer graphics and interactive techniques (SIGGRAPH '00), it was shown that the rendering quality is proportional to the number of views and the available depth. When more depth information is used, fewer references are needed. Disadvantageously though, depth image-based rendering methods have been error-prone due to inaccurate depth values and due to the precision limitation of synthesis methods.

Depth acquisition is a complicated problem by itself. Usually systems utilize an array of cameras and the depth of an object can be estimated by corresponding object features at different camera positions. This approach is prone to errors due to occlusions or smooth surfaces. Recently, several active methods for depth acquisition have been used, such as depth cameras and time-of-flight cameras. Nevertheless, the captured depth maps still present noise levels that, despite low amplitude, adversely affect the view synthesis procedure.

In order to cope with inaccurate geometry information, certain conventional methods may apply a pre-processing step to filter the acquired depth maps. For example, in Kwan-Jung Oh et al., “Depth Reconstruction Filter and Down/Up Sampling for Depth Coding in 3-D Video,” Signal Processing Letters, IEEE, vol. 16, no. 9, pp. 747,750 (September 2009), a filtering method is proposed that smoothes the depth map while enhancing its edges. In Shujie Liu et al., “New Depth Coding Techniques With Utilization of Corresponding Video”, IEEE Transactions on Broadcasting, vol. 57, no. 2, pp. 551, 561, (June 2011), the authors propose a trilateral filter, which adds the corresponding color information to the traditional bilateral filter to improve the matching between color and depth. Nevertheless, the pre-processing of depth information does not eliminate synthesis artifacts and is computationally intensive and impractical for low-latency systems.

A known problem relating to view merging is the color mismatch between views. In Yang L et al., (2010) “Artifact reduction using reliability reasoning for image generation of FTV” J Vis Commun Image Represent, vol 21, pp 542-560 (July-August 2010), the authors propose the warping of a reference view to another reference view position in order to verify the correspondence between the two references. Unreliable pixels (that is, pixels that have a different color value in the two references) are not used during warping. In order not to reduce the number of reference pixels, the authors from “Novel view synthesis with residual error feedback for FTV,” in Proc. Stereoscopic Displays and Applications XXI, vol. 7524, January 2010, pp. 75240L-1-12 (H. Furihata et al.) propose the use of a color-correcting factor obtained from the difference between the corresponding pixels in the two reference views. Although this proposed method improves rendering quality, the improvement comes at the cost of increased computational time and memory resources to check pixel color and depth.

Since conventional synthesis methods are optimized for reference views that are relatively close to each other, such DIBR methods are less effective for light field sub-sampling, where the reference views are farther apart from each other. Furthermore, to reduce the associated data handling load, these conventional methods for view synthesis usually target horizontal parallax views only and vertical parallax information is left unprocessed.

In the process of 3D coding standardization (ISO/IEC JTC1/SC29/WG11, Call for Proposals on 3D Video Coding Technology, Geneva, Switzerland, March 2011), view synthesis is being considered as part of the 3D display processing chain since it allows the decoupling of the capturing and the display stages. By incorporating view synthesis at the display side, fewer views need to be captured.

While the synthesis procedure is not part of the norm, the MPEG group provides a View Synthesis Reference Software (VSRS) that is used in the evaluation of 3D video systems. The VSRS software implements techniques for view synthesis, including all three stages: view warping, view merging and hole filling. Since VSRS can be used with any kind of depth (including ground-truth depth maps obtained from computer graphics models up to estimated depth maps from stereo pair images), many sophisticated techniques are incorporated to adaptively deal with depth map imperfections and synthesis inaccuracies. For the VSRS synthesis, only two views are used to determine the output; a left view and a right view.

First, the absolute value of the difference between the left and right depths is compared to a pre-determined threshold. If this difference is larger than a pre-defined threshold (indicating that the depth values are very different from each other, and possibly related to objects in different depth layers), then the smallest depth value determines the object that is closer to the camera, and the view is assumed to be either the left view or the right view. Where the depth values are close to each other, then the number of holes is used to determine the output view. The absolute difference between the number of holes in the left and right views is compared to a pre-determined threshold. Where both views have a similar number of holes, then an average of the pixels coming from both views is used. Otherwise, the view with fewer holes is selected as the output view. This procedure is effective for unreliably warped pixels. It detects wrong values and rejects them, but at the same time requires a high computational cost, since a complicated view analysis (depth comparison and hole counting) is performed for each pixel separately.

VSRS uses a horizontal camera arrangement and utilizes only two references. It is optimized for synthesis of views with small baselines (that is, views that are close to each other). It does not use any vertical camera information and is not well-suited for use in light field synthesis.

In Graziosi et al., “Depth assisted compression of full parallax light fields”, IS&T/SPIE Electronic Imaging. International Society for Optics and Photonics (Mar. 17, 2015), a synthesis method that targets light fields and uses both horizontal and vertical information was introduced. The method adopts aspects of Multiple Reference Depth-Image Based Rendering (MR-DIBR) and utilizes multiple references with associated disparities to render the light field. In this approach, disparities are first forward warped to a target position. Next, a filtering method is applied to the warped disparities to mitigate artifacts such as cracks caused by inaccurate pixel displacement. The third step is the merging of all of the filtered warped disparities. Pixels with smaller depths (i.e., closest to the viewer) are selected. VSRS blends color information from two views with similar depth values and obtains a blurred synthesized view, in contrast to Graziosi et al., “Depth assisted compression of full parallax light fields”, IS&T/SPIE Electronic Imaging International Society for Optics and Photonics (Mar. 17, 2015), which utilizes only one view after merging to preserve the high resolution of the reference view. Rendering time is reduced in VSRS due to simple copying of the color information from only one reference rather than interpolating several references.

Finally, the merged elemental image disparity is used to backward warp the color from the references' colors and to generate the final synthesized elemental image.

This view-merging algorithm tends to exhibit quality degradation when the depth values from the reference views are inaccurate. Methods for filtering depth values have been proposed in, for instance, U.S. Pat. No. 8,284,237, C. Fehn, “3D-TV Using Depth-Image-Based Rendering (DIBR),” in Proceedings of Picture Coding Symposium, San Francisco, Calif., USA, (December 2004), and Kwan-Jung Oh et al., “Depth Reconstruction Filter and Down/Up Sampling for Depth Coding in 3-D Video”, Signal Processing Letters, IEEE, vol. 16, no. 9, pp. 747, 750, (September 2009), but these approaches undesirably increase the computational requirements of the system and can increase the latency of the display system.

### BRIEF DESCRIPTION OF THE DRAWINGS

Embodiments of the invention are illustrated by way of example and not limitation in the figures of the accompanying drawings in which like references indicate similar elements.

FIG. 1 illustrates a model of an object.

FIG. 2 illustrates a texture of an object.

FIG. 3 illustrates relationships between the compression ratio and the depth of the object.

FIG. 4 shows the compression ratio where an object is close to a display screen.

FIG. 5 shows improvement in the compression ratio as an object moves farther from the display screen.

FIG. 6 illustrates a model of a further object.

FIG. 7 illustrates relationships between the compression ratio and the depth of the further object as the texture is applied to the further object.

FIG. 8 illustrates relationships between the compression ratio and the depth of the further object as another texture is applied to the further object.

FIG. 9 shows another texture of an object.

FIG. 10 illustrates a light field imaging system according to one embodiment of the invention.

FIG. 11 shows a location of a Quantum Photonic Imager (QPI®) imager in a light field display (LFD).

FIG. 12 shows an image displayed by a LFD when a texture is applied.

FIG. 13 is a flow diagram illustrating a method for rendering of a light field image according to one embodiment of the invention.

FIG. 14 illustrates a QPI imager with a rotated and translated lens array according to one embodiment of the invention.

FIG. 15 illustrates a distorted holographic element (“hogel”) on top of an undistorted hogel.

FIG. 16 is a chart illustrating relationships between a tilted degree and a maximum shift.

FIG. 17 shows an output of the MR-DIBR calibration data.

FIG. 18 shows the difference between an original image and a synthesized image.

FIG. 19 shows an object and a camera.

FIG. 20 shows an object area covered by a camera frustum.

FIG. 21 shows an occlusion area of the two directions of the camera.

FIG. 22 shows an area covered by three views of the camera.

FIG. 23 shows a central viewing angle of the camera.

FIG. 24 shows a side view of the occlusion area.

FIG. 25 is a display of an input orthographic light field image.

FIG. 26 is a zoomed-in view of the input orthographic light field image.

FIG. 27 shows a reference view grid for four corners views.

FIG. 28 shows four reference images for four corners of a cube (or die).

FIG. 29 is a flow diagram illustrating another method for rendering of a light field image according to one embodiment of the invention.

FIG. 30 shows a synthesized image where the four corners view is utilized.

FIG. 31 shows a synthesized image where the four corners view is used with a depth threshold.

FIG. 32 shows a synthesized image using the four corners view and a central view.

FIG. 33 shows a perspective reference view grid for comparing outputs of the perspective and orthographic MR-DIBR methods.

FIG. 34 shows an orthographic reference grid to compare the outputs of the perspective and orthographic MR-DIBR methods.

FIG. 35 shows perspective views synthesized by the perspective MR-DIBR method.

FIG. 36 shows perspective views synthesized by the orthographic MR-DIBR method.

FIG. 37 shows orthographic views synthesized by the perspective MR-DIBR method.

FIG. 38 shows orthographic views synthesized by the orthographic MR-DIBR method.

FIG. 39 is an example illustrating multiple matching blocks within an image.

FIG. 40 is a flow diagram illustrating a method for depth estimation according to one embodiment of the invention.

FIG. 41 illustrates a horizontal disparity map of an elemental image and a conversion of a disparity map to a depth map.

FIG. 42 is a flow diagram illustrating a method for depth estimation of one or more light field images according to one embodiment of the invention.

FIG. 43 is an example illustrating a bi-directional search technique.

FIG. 44 is an example illustrating a power-of-2 search technique with a one-pixel shift.

FIG. 45 illustrates application of the bi-directional search technique on a test image.

FIG. 46 shows an estimated depth map with a 3×3 block.

FIG. 47 shows the difference of the reference depth map and a 3×3 block estimation.

FIG. 48 shows an estimated depth map with a 5×5 block.

FIG. 49 shows the difference of the reference depth map and a 5×5 block estimation.

FIG. 50 shows an estimated depth map using a conventional depth estimation method.

FIG. 51 shows the difference of the reference depth map using the conventional depth estimation method.

FIG. 52 is a disparity map for 20×20 hogels at the center of a 54×64 hogel input image.

FIG. 53 shows an object boundary error caused by a background.

FIG. 54 shows an input light field depth map of a single die model.

FIG. 55 shows central pixels from hogels of the single die model's depth map.

FIG. 56 is a flow diagram illustrating a method for bounding box estimation according to one embodiment of the invention.

FIG. 57 is a flow diagram illustrating another method for bounding box estimation according to one embodiment of the invention.

FIG. 58 is a flow diagram illustrating another method for bounding box estimation according to one embodiment of the invention.

FIG. 59 shows a depth map histogram of a three-dice model.

FIG. 60 shows a first subspace of a scene.

FIG. 61 shows a second subspace of the scene.

FIG. 62 shows a third subspace of the scene.

FIG. 63 shows the boundary detected by a gradient operation on the depth map.

FIG. 64 shows a further first subspace of the scene.

FIG. 65 shows a further second subspace of the scene.

FIG. 66 shows a further third subspace of the scene.

FIG. 67 shows a second index of each object within the scene.

FIG. 68 shows errors on bounding pixels.

FIG. 69 shows central pixels on each hogel.

FIG. 70 shows the bounding boxes from a central view.

FIG. 71 shows the bounding boxes from a top view.

FIG. 72 shows the bounding boxes from a bottom view.

FIG. 73 shows the bounding boxes from a left view.

FIG. 74 shows the bounding boxes from a right view.

FIG. 75 shows a covered area by the QPI imager.

FIG. 76 shows the covered area on an XY plane.

FIG. 77 illustrates multiple views from different hogels.

FIG. 78 illustrates an output image of a die with a hogel size of 40×40.

FIG. 79 illustrates an output image of a die with a hogel size of 80×80.

FIG. 80 shows a ray transform projection for two cameras.

FIG. 81 shows a reference camera positioned farther from a scene that can cover the field of view (FOV) of four cameras.

FIG. 82 is an example of a reference image.

FIG. 83 is an example of a rendered image.

FIG. 84 is an example of another rendered image.

FIG. 85 is an example of a further rendered image.

FIG. 86 shows an example of an occlusion area.

FIG. 87 is a graph illustrating a relationship between a depth precision and a distance from a camera.

FIG. 88 is a flow diagram of a method for synthesizing a light field image according to one embodiment of the invention.

FIG. 89 is an example of a synthesized light field image.

FIG. 90 is an example of another synthesized light field image.

FIG. 91 is a block diagram of a data processing system, which may be used with one embodiment of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. Random access refers to access (read/write) to a random offset of a file at least once during a read/write input/output operation.

The compression methods described herein below address a number of deficiencies found in the conventional DIBR compression approaches. Using such compression methods, light field images can be reconstructed using either perspective projection light field images (e.g., elemental images or hogel images) or by using orthographic projection light field images (e.g., subimages, subaperture images, etc.). The quality and compression ratios of the output images using the compression methods described herein are thus dependent on the scene characteristics such as depth and shape of the objects.

Methods and systems for compression of light field images using Multiple Reference Depth Image-Based Rendering techniques (MR-DIBR) are disclosed. The methods and systems enhance light field image quality of compressed light field images using reference depth (or disparity) and color maps to enable hole filling and crack filling in compressed light field image data sets.

According to one aspect of the invention, the method receives image data of a light field image of a scene. The light field image includes one or more subimages. The method produces the light field image on a display surface of a display device based on the received image data. The method calibrates the display surface based on display calibration parameters. The method generates a new light field image on the calibrated display surface based on a rendering area for each of the subimages.

According to another aspect of the invention, the method generates a merged orthographic light field image from one or more orthographic light field images. For each of the orthographic light field images, the method determines a distance between the orthographic light field image and a further orthographic light field image, thereby producing one or more distances. The method arranges the orthographic light field images based on the determined distances.

According to another aspect of the invention, the method receives image data of a light field image that includes one or more subimages. The method generates a disparity map for the light field image based on the image data by applying a stereo matching algorithm to a pair of subimages of the one or more subimages. The method verifies the disparity map using other subimages from the one or more subimages. The method converts the disparity map to a depth map for the light field image.

According to another aspect of the invention, the method receives image data of a light field image of a scene. The scene includes one or more objects. The method divides the scene into one or more subspaces based on a depth distribution. The method, for each of the subspaces, computes one or more bounding boxes. Each of the bounding boxes surrounds an object within the subspace.

According to another aspect of the invention, the method receives image data of a light field image of a scene. The scene includes one or more objects. For each of the objects, the method computes a boundary of the object in the scene, and calculates a bounding box for the object based on the computed boundary.

According to another aspect of the invention, the method receives image data of a light field image of a scene. The scene includes one or more objects. For each of the objects, the method searches a neighboring pixel to determine a boundary of the object, and calculates a bounding box for the object based on the determined boundary.

According to another aspect of the invention, the method generates a synthesized light field image that includes a plurality of gaps. The method forward warps a reference depth of the synthesized light field image to produce a synthesis depth map. The method applies a gap filling filter on the synthesis depth map. The method backward warps the synthesize depth map based on a reference texture to produce a rendered texture of the synthesized light field image.

1. MR-DIBR Encoding and Decoding Based on Perspective Projection

As detailed in U.S. Pub. No. 2016/0021355, entitled “Preprocessor for Full Parallax Light Field Compression”, the disclosure of which is incorporated herein by reference, MR-DIBR enables the reconstruction of other perspectives from reference images and from reference disparity maps. Reference images and reference disparity maps are initially selected via a “visibility test”. The visibility test makes use of: 1) the distance of the objects from a modulation surface, and 2) the display's FOV to determine and define the reference images and disparity maps.

In general, a scene that contains objects farther from the modulation surface tends to result in a smaller number of reference images and reference disparity maps as compared to a scene that contains objects that are closer to the modulation surface. Smaller numbers of reference images and reference disparity maps result in a higher compression ratio. In general, however, higher compression ratios also mean greater degradation in the decoded image. The relationship between decoded image quality and the depth of the objects in the scene, with objective metrics of compression ratio, peak signal-to-noise ratio (PSNR), and structural similarity (SSIM), is discussed below as a brief background and introduction to various aspects of the invention.

1.1 Compression Ratio with Different Depths

The distance between two sampling cameras is determined by the formula:

depth_obj*tan(cam_FOV/2)

where depth_obj is the depth of the object and cam FOV is FOV of the camera.

Below is a discussion regarding the performance of MR-DIBR and traditional compression algorithms using an exemplar QPI imager-based light field display device (or QPI light field display device).

This new class of QPI light field display device is disclosed, for instance, in U.S. Pat. No. 7,623,560, U.S. Pat. No. 7,767,479, U.S. Pat. No. 7,829,902, U.S. Pat. No. 8,049,231, U.S. Pat. No. 8,243,770, U.S. Pat. No. 8,567,960, and U.S. Pat. No. 8,098,265, the disclosures of which are incorporated herein by reference. In some embodiments, the disclosed light emitting structures and devices referred to herein may be based on a QPI imager. The QPI light field display device may feature high brightness, very fast multi-color light intensity and spatial modulation capabilities, all in a very small single device size that includes all necessary image processing drive circuitry. In one embodiment, the solid state light (SSL) emitting pixels of the QPI light field display device may be either a light emitting diode (LED) or laser diode (LD), or both, whose on-off state may be controlled by a drive circuitry contained within a complementary metal-oxide-semiconductor (CMOS) chip (or device) upon which the emissive micro-scale pixel array of the imager is bonded and electronically coupled. The size of the pixels that include emissive arrays of such imager device is typically in the range of approximately 5-20 microns with a typical emissive surface area being in the range of approximately 15-150 square millimeters. The pixels within the emissive micro-scale pixel array devices are individually addressable spatially, chromatically and temporally, typically through the drive circuitry of its CMOS chip. The brightness of the light generated by such QPI light field display device can reach multiple 100,000 cd/m2 at reasonably low power consumption.

However, it is to be understood that the QPI light field display device is merely an example of a type of device that may be used. Thus, in the description to follow, references to QPI imager, display, or display device are to be understood to be for purposes of specificity in the embodiments disclosed, and not for any limitation of aspects of the invention.

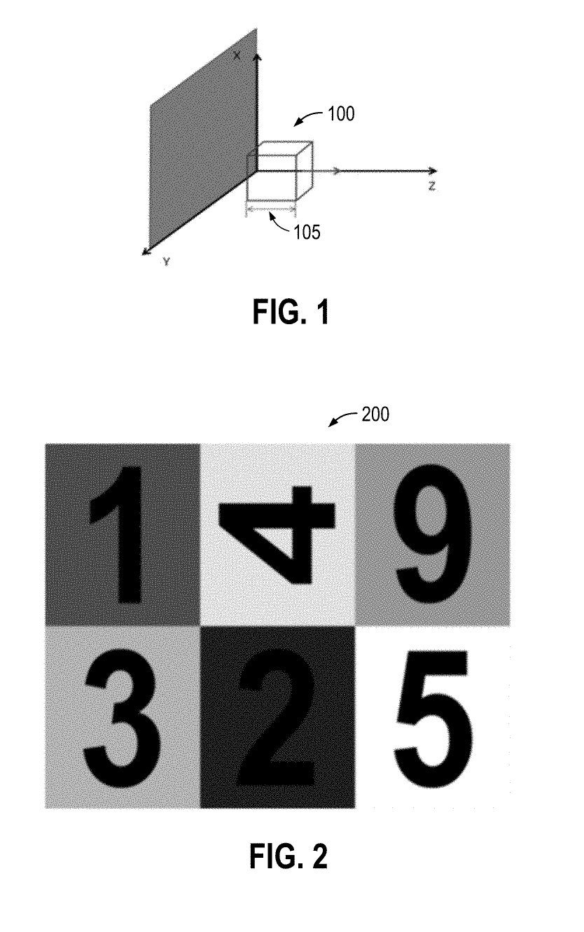

With reference to FIG. 1, an object 100 (e.g., a cube or die) may include multiple equal faces, with each face having equal sides (e.g., side 105). As shown in FIG. 2, texture 200 may be applied to the object 100. In more detail, Table 1 below shows the parameters of the QPI-based LFD and Table 2 below shows the parameters of the object 100. In one embodiment, side 105 of the object 100 may be 8 millimeters (mm). In one embodiment, the modulation surface is located on the xy-plane with z=0, and the depth of the object 100 may be variable.

TABLE 1
QPI-based LFD parameters

| Parameter | Value |
|---|---|
| FOV | 25° |
| Number of QPI Imagers | 6 × 4 |
| Number of Hogels per QPI Imager | 9 × 16 |
| Number of Anglets Per QPI Imager | 360 × 640 |
| Number of Anglets Per Light Field | 2160 × 2560 |
| Hogel Size | 0.4 mm × 0.4 mm |

TABLE 2
Dice Parameters

| | Model Position | | | Model Look-At | | | Model Up | | | | | |
|---|---|---|---|---|---|---|---|---|---|---|---|---|
| | (mm) | | | Vector | | | Vector | | | Scale Factor | | |
| | X | y | z | x | y | z | x | Y | z | x | Y | z |
| Die 1 | 0 | 0 | z1 | 1 | 0 | 0 | 0 | 1 | 0 | 8 | 8 | 8 |

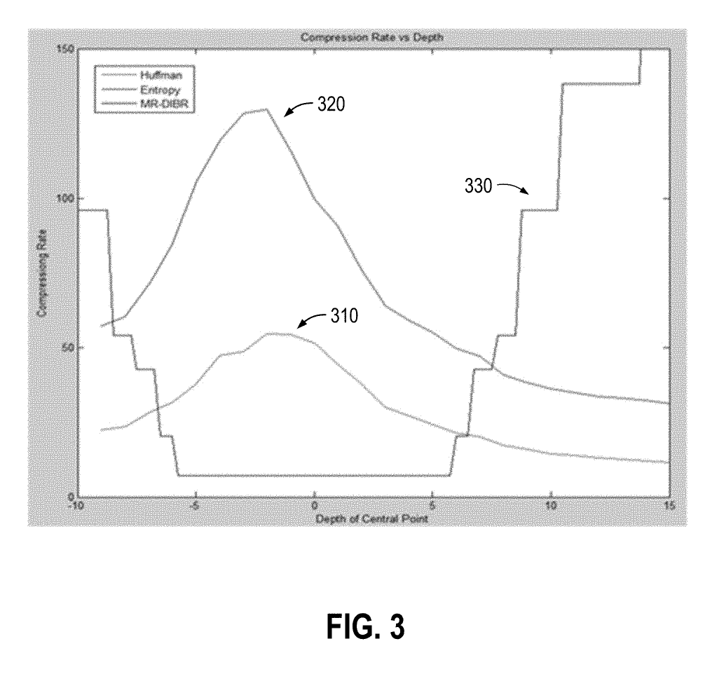

With reference to FIG. 3, the relationships between the compression ratio and the depth of object 100 may be computed and represented graphically based on the three compression algorithms listed in Table 1-2 below.

TABLE 1-2
Compression Method Comparison

| | |
|---|---|
| Algorithm 1 | Huffman code—an optimal prefix code commonly |
| | used for lossless data compression. |
| Algorithm 2 | Entropy of image—generates the upper bound of |
| | lossless compression. |
| Algorithm 3 | MR-DIBR—Multi Reference Depth Image-Based |
| | Rendering. |

As shown in FIG. 3, entropy coding (as represented by graph 320) and Huffman coding (as represented by graph 310) work best when the depth of the object 100's center point is about z=−3 mm, as many elemental images display only one face of the object 100 and the complexity of the elemental images is low, leading to low entropy (i.e., a higher compression ratio). Starting from this position, changing the distance from the display screen reduces the compression ratio for entropy coding. In contrast, MR-DIBR (as represented by graph 330) works better as object 100 moves farther from the display screen.

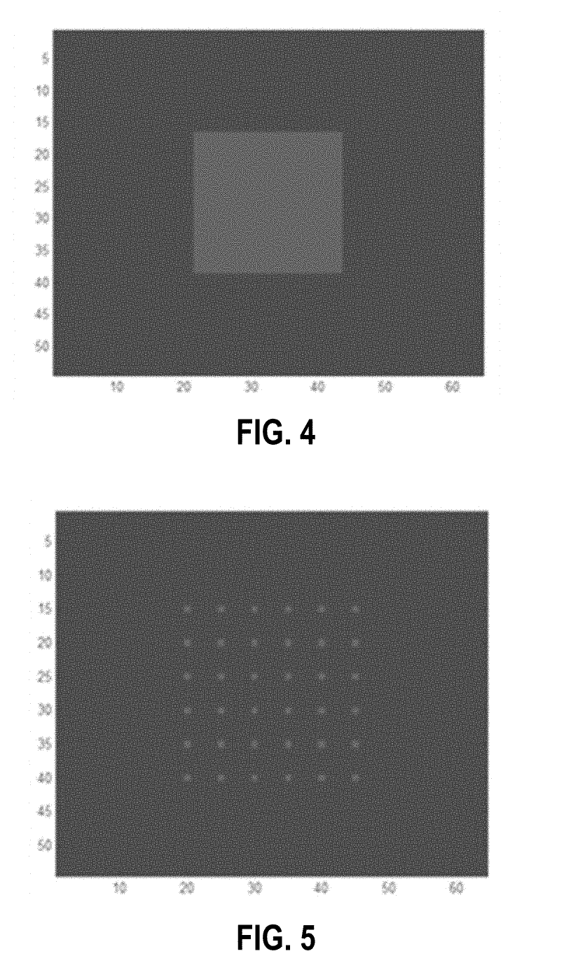

FIG. 4 shows the compression ratio where object 100 is close to a display screen. For instance, when z=4.25 mm, the front face of object 100 is very close to the modulation surface, so the visibility test selects every hogel addressing the bounding box. With reference to FIG. 5, which shows improvement in the compression ratio as object 100 moves farther from the display screen (i.e., modulation surface), the density of the view grid decreases significantly.

Therefore, the compression ratio (which is proportional to the number of reference images) of MR-DIBR encoding depends on the distance of the bounding boxes of object 100 from the modulation surface. In contrast, the compression ratio of entropy coding is determined by the shape and the texture complexity of object 100.

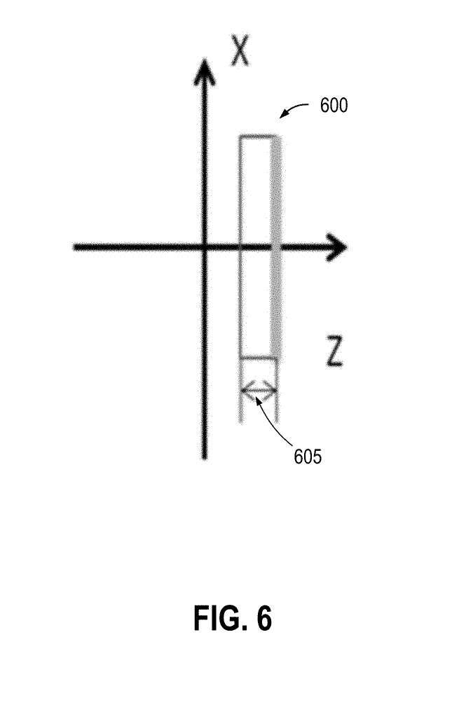

With reference to FIG. 6, an object 600 may be of a different shape than object 100 of FIG. 1. In one embodiment, object 600 may be of extended length and includes multiple faces, with each face being approximately rectangular-shaped. In one embodiment, a face of object 600 may include a side 605 (which may be 1 mm).

FIG. 7 illustrates the relationships between the compression ratio and the depth of object 600 as the texture 200 of FIG. 2 is applied to object 600. As shown in FIG. 7, Huffman coding (as represented by graph 710) and entropy coding (as represented by graph 720) have an optimal compression ratio when the depth of the object 600 is about z=1 mm. Again, MR-DIBR (as represented by graph 730) has a better compression ratio as object 600 moves farther from the display screen (i.e., as the depth of object 600 increases).

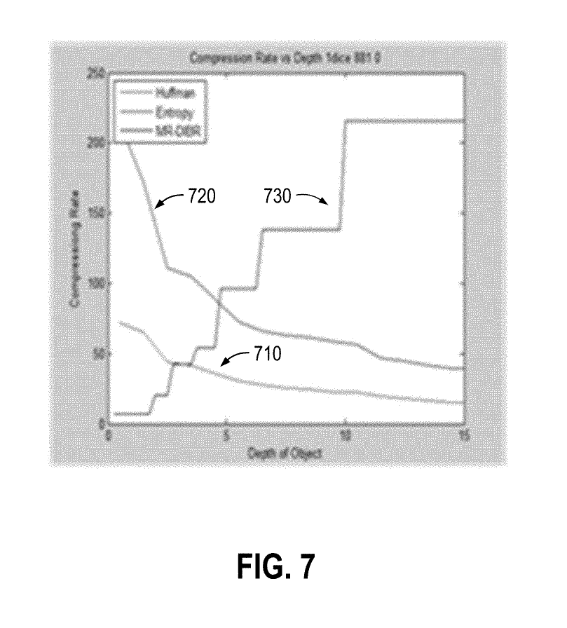

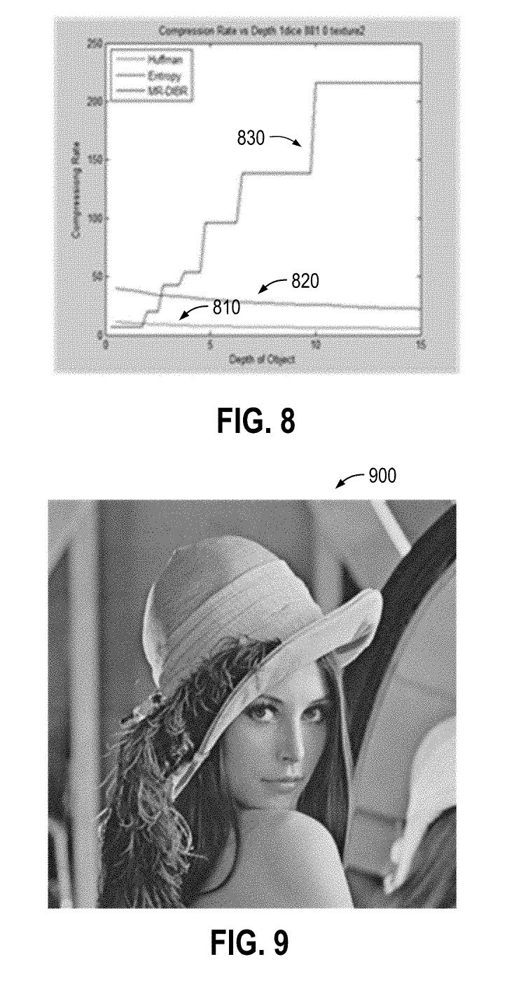

FIG. 8 illustrates the relationships between the compression ratio and the depth of object 600 as texture 900 (e.g., a movie poster) of FIG. 9 is applied to object 600. As shown in FIG. 8, Huffman coding (as represented by graph 810) and entropy coding (as represented by graph 820) also have an optimal compression ratio when the depth of object 600 is about z=1 mm. As previously described with respect to FIG. 7, MR-DIBR (as represented by graph 830) has a better compression ratio as object 600 moves farther from the display screen (or modulation surface).

Accordingly, FIGS. 7 and 8 show that the compression ratio of MR-DIBR does not depend on the size of object 600 or the texture of the object 600. However, the performance of entropy coding and Huffman coding changes based on the shape and the texture of object 600. In entropy coding and Huffman coding, for example, the compression ratio is higher when object 600 is located near the display screen. This is because object 600 is close to the cameras and the cameras only record a small portion of object 600's texture, resulting in a low frequency capture. However, when object 600 is farther from the cameras, the cameras see more object details and record a higher frequency image, which reduces the compression ratio. The shape of the object 600 in these experiments affected the location of the highest compression ratio. The thickness of the object 600 acts like a distance bias and moves the location of object 600's face closest to the cameras. The shape of the object 600 can have other effects depending on the convexity/concavity and the details of the features of the shape.

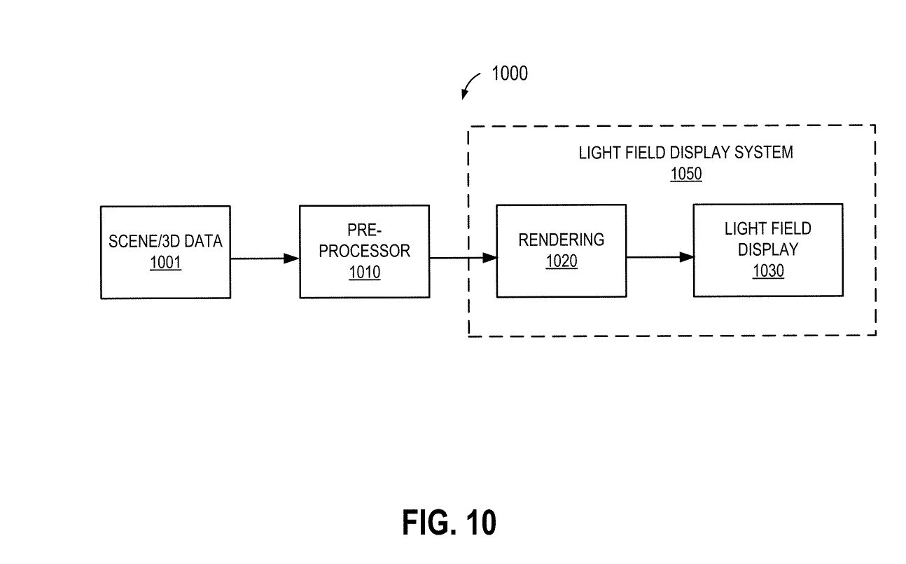

FIG. 10 illustrates a light field imaging system according to one embodiment of the invention. Referring to FIG. 10, light field imaging system 1000 may include a pre-processor 1010, and a light field display system 1050 having a rendering unit 1020 and a light field display 1030.

In one embodiment, pre-processor 1010 may capture, render, or receive light field input data (or scene/3D data) 1001 that represents an object (e.g., object 100 of FIG. 1 or object 600 of FIG. 6). Alternatively, in another embodiment the light field input data 1001 may be captured or rendered by a separate unit, e.g., a capture or render unit (not shown). Moreover, the pre-processor 1010 may generate a priori information associated with the light field input data 1001. For example, as described in more detail herein below, the pre-processor 1010 may perform stereo matching and/or depth estimation on the light field input data 1001 to obtain a representation of the spatial structure of a scene. Subsequently, the pre-processor 1010 may provide the information and the light field input data 1001 to the rendering unit 1020 for rendering. For instance, the rendering unit 1020 may perform MR-DIBR on the light field input data 1001 based on perspective and/or orthographic projection to generate compressed or rendered images (e.g., elemental images or hogel images). The compressed or rendered images may then be provided to the light field display 1030 for display on a display screen (i.e., modulation surface).

1.2 Display Calibration Parameters in MR-DIBR Decoding (Three Degrees of Freedom)

The handling of display calibration parameters in MR-DIBR decoding is discussed below. It is assumed calibration errors in a display occur in the xy-plane in the form of a shift in the x axis, a shift in the y axis, or a rotation around the z axis. For purposes of illustration, the display of the instant example is assumed upright, the x axis is assumed along the horizontal direction of the display, the y axis is assumed along the vertical direction of the display and the +z axis is assumed to be extending from the display toward the viewer with the right-handed notation. The center of the display in the xy-plane is assumed to be the origin (0,0,0) in world coordinates.

In one embodiment, calibrated images are rendered from reference images directly. In addition to the reference images, three calibration parameters (dx, dy, and Ω) may be utilized, where dx is the horizontal translation error (or horizontal displacement), dy is the vertical translation error (or vertical displacement), and Ω is the rotation error (or tilt angle) in around the z axis in a counter-clockwise direction.

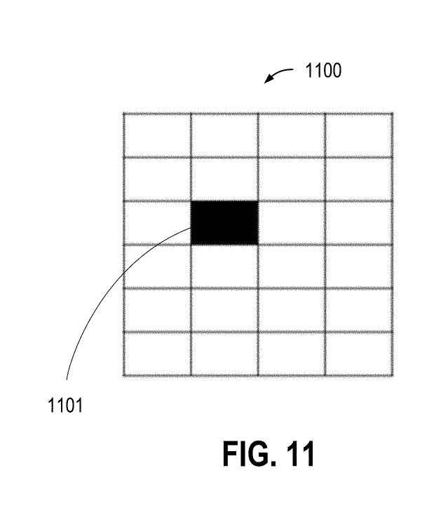

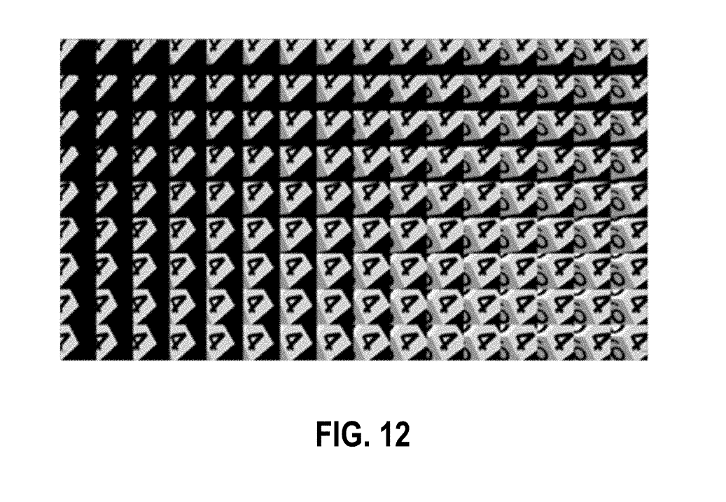

FIG. 11 shows a location of a QPI imager in a light field display (LFD) 1100, and FIG. 12 shows an image displayed by the LFD 1100 when a texture (e.g., texture 200 of FIG. 2) is applied. For purposes of example, as shown in FIG. 11, LFD 1100 is assumed to include a 4×6 array of tiled QPI imagers (e.g., 3D QPI imagers). The specifications of the exemplar LFD are previously shown in Table 1. For calibration, QPI imager 1101, which represents location (3, 2) on the LFD 1100, is selected as depicted in FIG. 11.

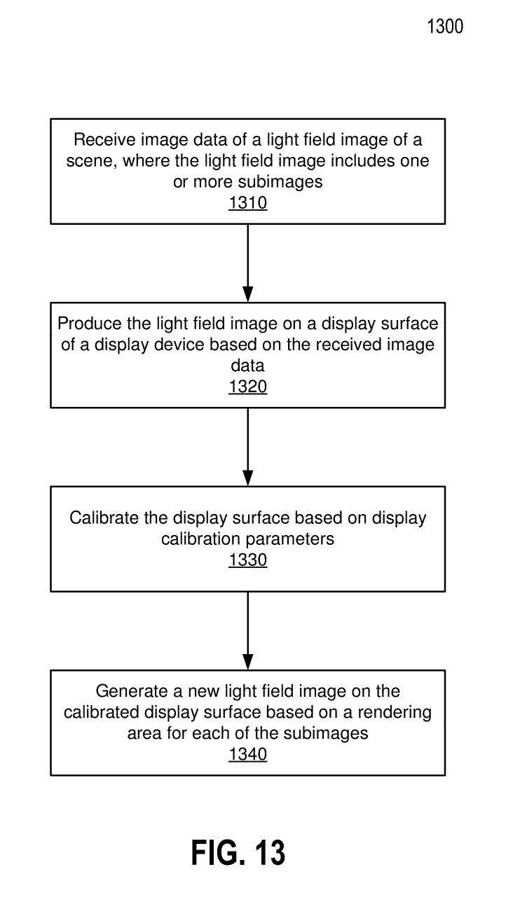

FIG. 13 is a flow diagram illustrating a method for rendering of a light field image according to one embodiment of the invention. Process 1300 may be performed by processing logic that includes hardware (e.g. circuitry, dedicated logic, etc.), software (e.g., embodied on a non-transitory computer readable medium), or a combination thereof. For example, process 1300 may be performed by rendering unit 1020 of FIG. 10.

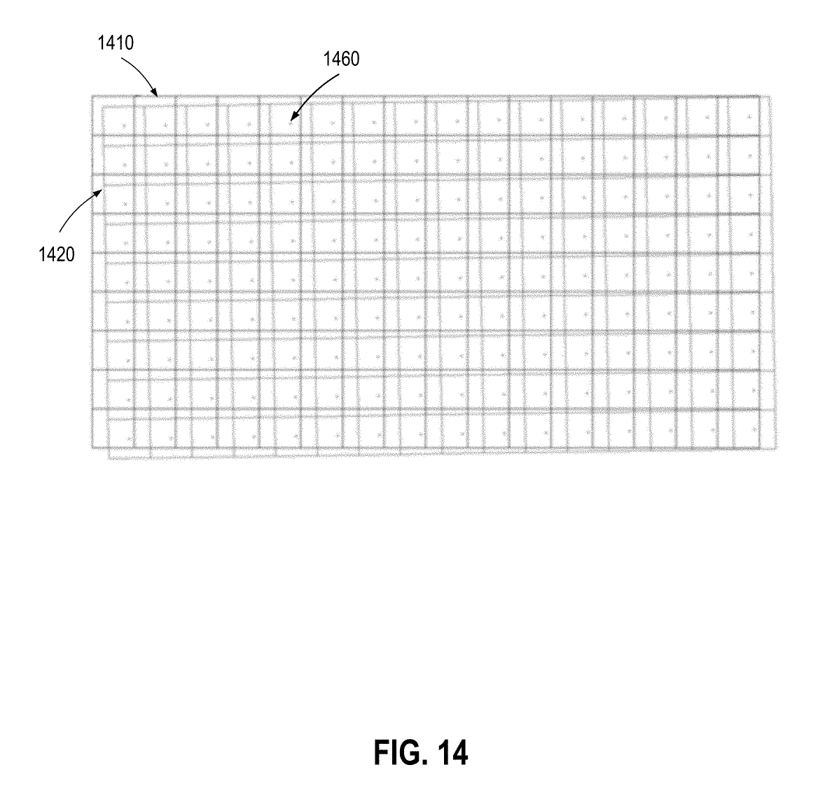

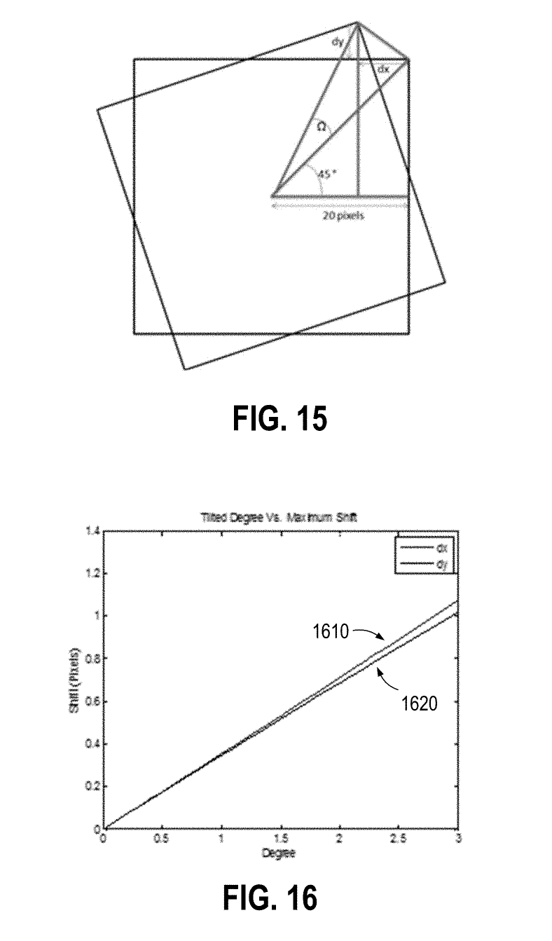

Referring to FIG. 13, at block 1310, the processing logic receives image data of a light field image of a scene, where the light field image includes one or more subimages (e.g., elemental images or hogel images). At block 1320, the processing logic produces the light field image on a display surface (e.g., lens array) of a display device based on the received image data. At block 1330, the processing logic calibrates the display surface based on display calibration parameters. As an illustrated example (also refer to FIG. 15), a realistic worst-case-like scenario set of calibration parameters of dx=0.13 mm, dy=−0.06 mm, and Ω=0.9° are used. Referring to FIG. 14, a QPI imager 1410 (e.g., 9×16 hogel array) and a rotated and translated micro-lens array 1420 according to one embodiment of the invention are illustrated. In FIG. 14, the top-left hogel of QPI imager 1410 shifts nearly one-third of the hogel size. The maximum shift from original location happens for the corner hogels, since they are farthest from the center of the QPI imager. The relationship between tilt degree and maximum shift is derived below.

dx=20\sqrt{2}*[cos(45)−cos(Ω+45)] (1)

dy=20\sqrt{2}*[sin(Ω+45)−sin(45)] (2)

From the equations (1) and (2), tilt degree vs. maximum shift is shown in FIG. 16 and Table 3.

TABLE 1
Tilt Degree vs. Maximum Shift

| Ω (°) | 0 | 0.1 | 0.2 | 0.3 | 0.4 | 0.5 | 0.6 | 0.7 | 0.8 | 0.9 | 1 | 2 | 3 |
|---|---|---|---|---|---|---|---|---|---|---|---|---|---|
| dx (pix) | 0 | 0.0349 | 0.0699 | 0.105 | 0.1401 | 0.1753 | 0.2105 | 0.2458 | 0.2812 | 0.3166 | 0.3521 | 0.7102 | 1.0741 |
| dy (pix) | 0 | 0.0349 | 0.0697 | 0.1044 | 0.1391 | 0.1738 | 0.2083 | 0.2428 | 0.2773 | 0.3117 | 0.346 | 0.6858 | 1.0193 |

Typically, the tilt error is smaller than 1°, which means dx (as represented by graph 1610 of FIG. 16) and dy (as represented by graph 1620 of FIG. 16) are less than 0.4 pixel for a single hogel that is close to the center of the display. Similar formulas can be written for all of the hogels that belong to a display and results follow the same trend. From this analysis, it can be concluded that lens tilt (or rotation) only affects the center position of each hogel but makes little difference to the rendering area shape.

Referring back to FIG. 13, at block 1340, the processing logic generates a new light field image on the calibrated display surface based on a rendering area for each of the subimages. To generate or render the new image with calibration, the center of new hogels (e.g., hogel center 1460) is determined, and then the render area for each hogel is determined. As previously described, rendering the calibrated images may be performed, for example, using MR-DIBR.

Based on the above analysis, synthesizing a light field image, including the display calibration parameters, using MR-DIBR can be achieved in a piece-wise manner where each hogel may be considered as a square (or rectangular image) centered at the center position calculated from the calibration data. In this manner, the overall shift and rotation of the display micro lens array (MLA) is addressed while the compression data remains useful.

In one embodiment, the PSNR using the above test image is 23.28 dB. Comparing the output of the graphics processing unit (GPU), there is no significant difference in the output image and, based on such simulation, it may be possible to render calibrated elemental images via MR-DIBR.

2. MR-DIBR Based on Orthographic Projection

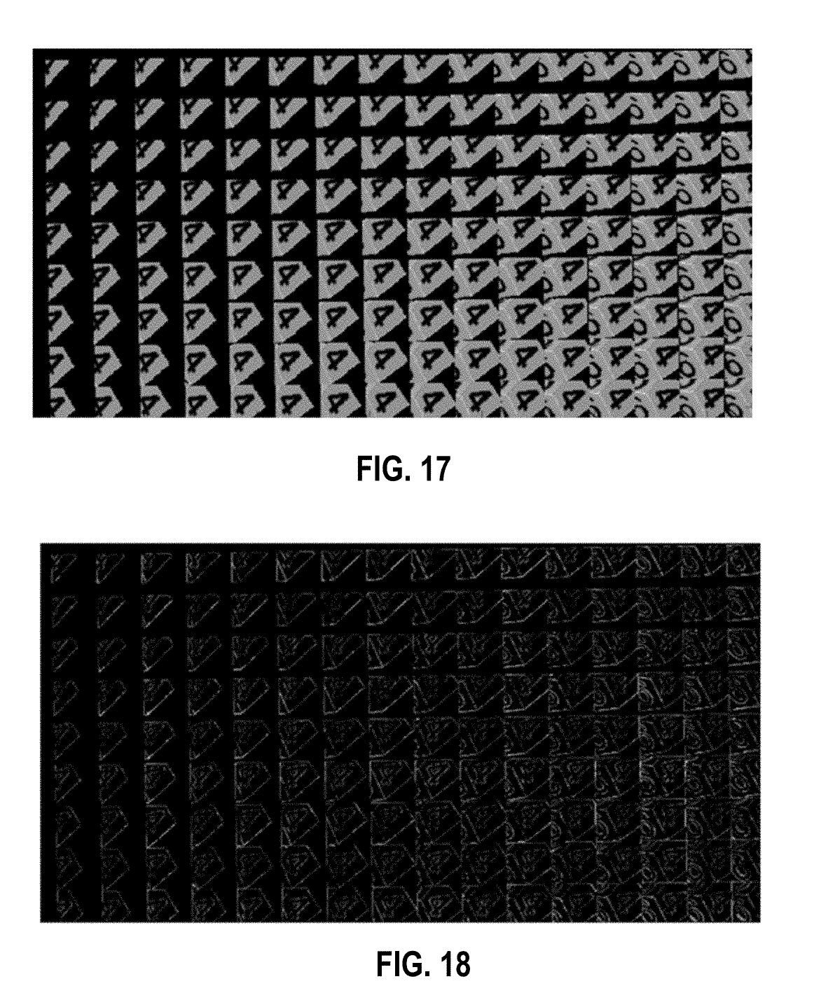

With reference to FIG. 17, which shows an output of the MR-DIBR calibration data, MR-DIBR with perspective projection (as previously described) gives improved results (i.e., higher compression ratio and less distortion in synthesized images) when objects are located farther from the camera. (See also, FIG. 18 which shows the difference of an original image and a synthesized image).

Objects located close to the camera, however, usually result in a high number of reference images. Accordingly, orthographic projection solves this issue and it has been determined that objects close to the camera can be represented by a small number of reference images that were created by orthographic projection.

2.1 Visibility Test for Orthographic Camera

The visibility test for orthographic projection images (or orthographic images) assumes the central view direction (i.e., normal to the camera surface, or camera optical axis) is always selected as the first view, because it is the frontal view of the object being captured. The visibility test is used to determine which other directions must be selected to cover the object.

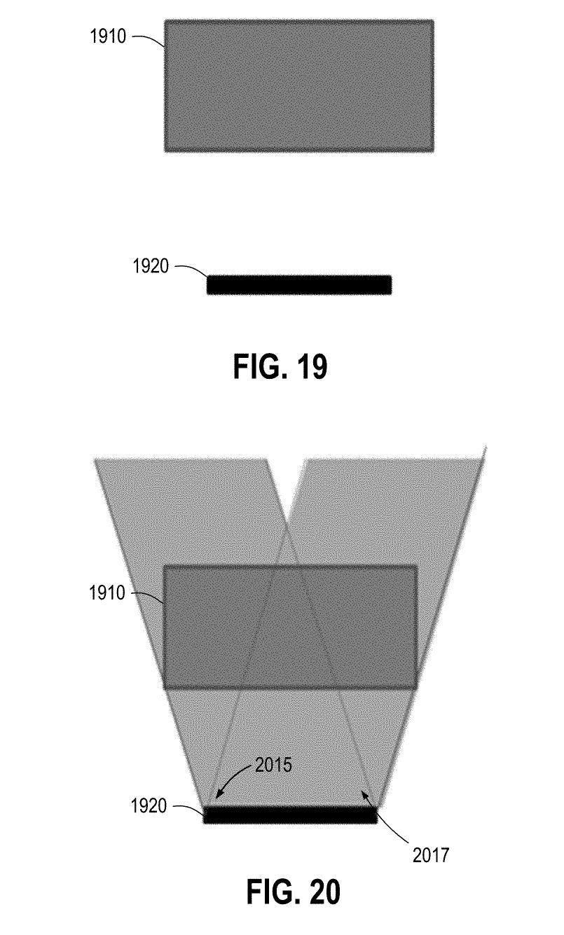

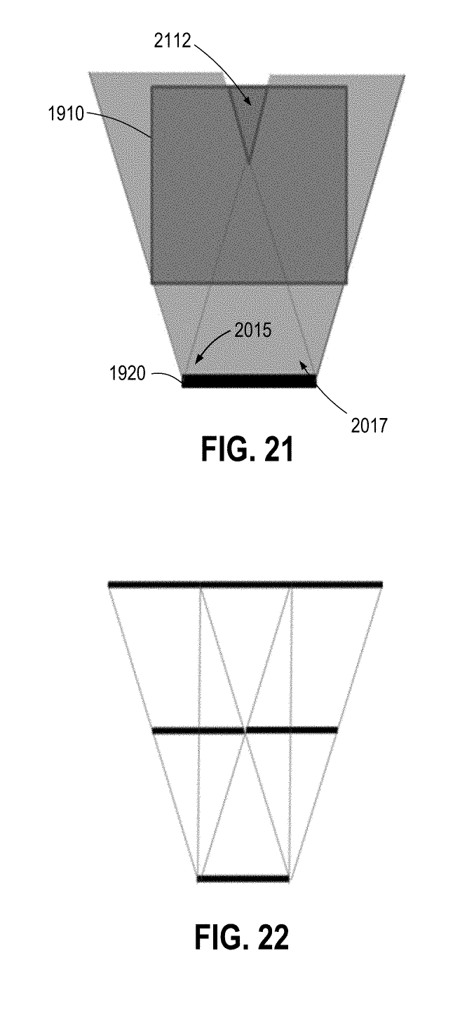

As shown in FIGS. 19 and 20, the visibility test starts from extreme angles 2015 and 2017 of the FOV of camera 1920 which are able to cover object 1910 and ends on the extreme angle on the other side of the object 1910. To cover the entire object, a user also needs to compute the step between two angles. As seen in FIGS. 21 and 22, a portion 2112 of object 1910 is not covered by the two extreme directions and the central direction, thus there is a need to provide additional orthographic views. The step between two view angles is determined by the furthest distance.

The equation for determining number of reference images is shown below:

N=z/{(W/2)/[tan(FOV/2)]},

where W is the width of screen, N is number of reference images, z is depth, and FOV is the FOV of the camera.

The distance between two reference images is computed by Dist=(Number of Hogels)/N−1.

If the distance Dist is larger than the width of the central view, then more views are added.

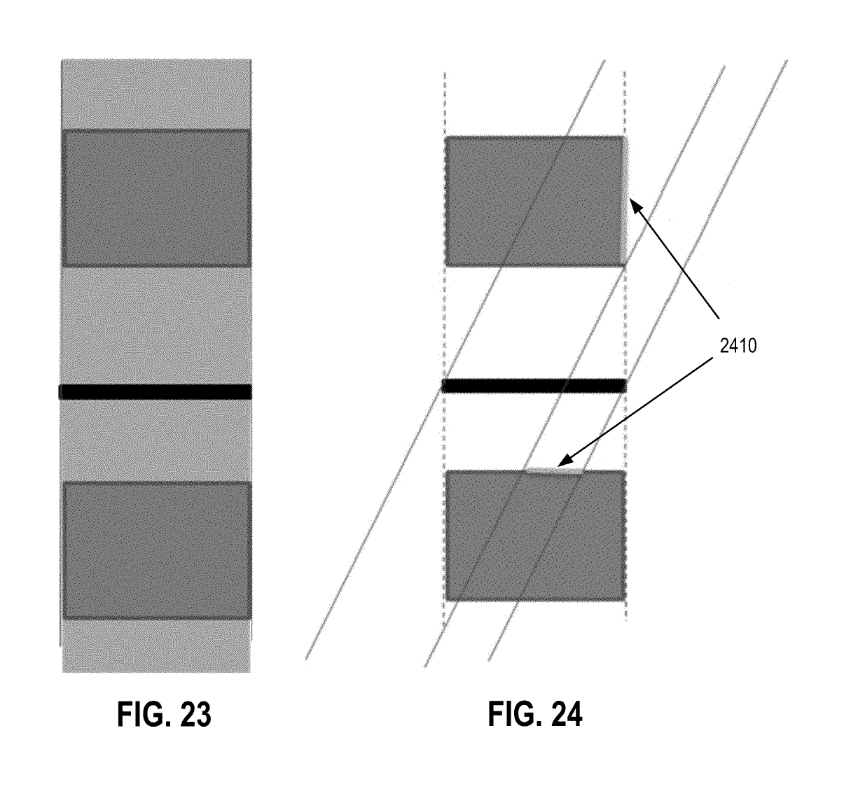

Although the central view and the extreme corner views typically capture the entire object, they may still miss some areas (e.g., areas 2410 of FIG. 24) of the object that are occluded (as shown in FIG. 23 and FIG. 24). To decrease the effect of occlusion, one more view is added to cover the occlusion area. The view angle is calculated by using the object distance from the camera and the size of the occlusion area.

2.2 MR-DIBR with Orthographic Projection

TABLE 4
LFD and Object Parameters

| LFD Parameter | Value |
|---|---|
| FOV | 25° |
| Number of QPI Imagers | 6 × 4 |
| Number of Hogels per QPI Imager | 9 × 16 |
| Number of Anglets Per QPI Imager | 360 × 640 |
| Number of Anglets Per Light Field | 2160 × 2560 |
| Hogel Size | 0.4 mm × 0.4 mm |

TABLE 5
Simulated Object Parameters
Object Parameters

| | Model Position | | | Model Look-At | | | Model Up | | | | | |
|---|---|---|---|---|---|---|---|---|---|---|---|---|
| | (mm) | | | Vector | | | Vector | | | Scale Factor | | |
| | x | y | z | x | y | z | x | y | z | x | y | z |
| Die 1 | −7.4 | 7 | 20 | −0.577 | −0.577 | −0.577 | 0 | 1 | 0 | 8 | 8 | 8 |
| Die 2 | −7 | −3 | −15 | −0.577 | 0.577 | 0.577 | 1 | 0 | 0 | 8 | 8 | 8 |

Table 4 and Table 5 show exemplar simulated LFD and object parameters.

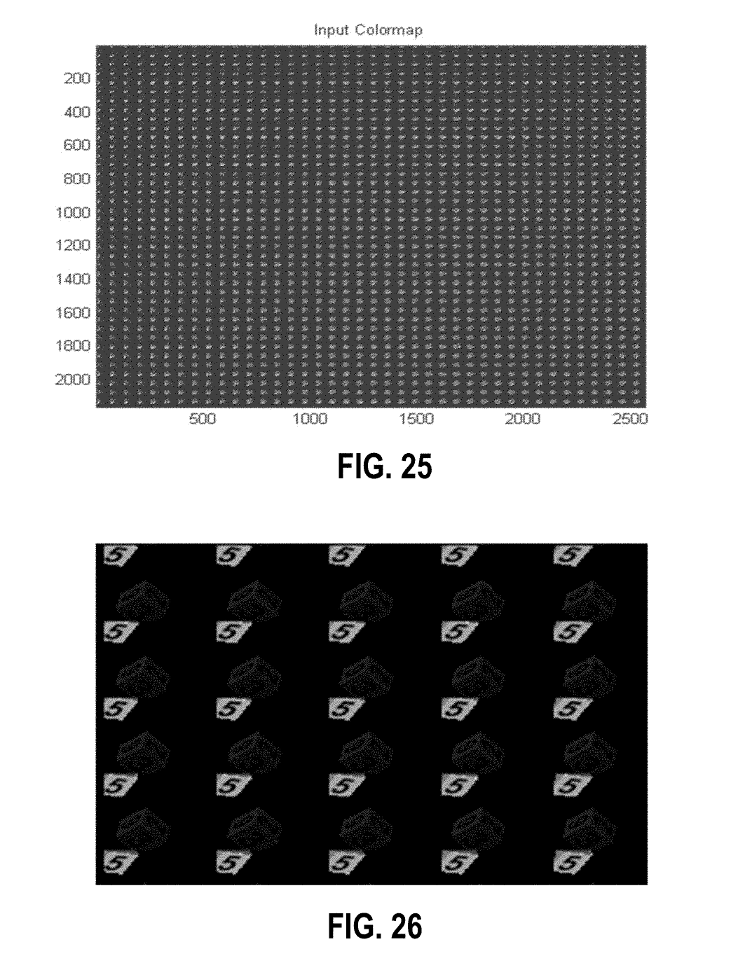

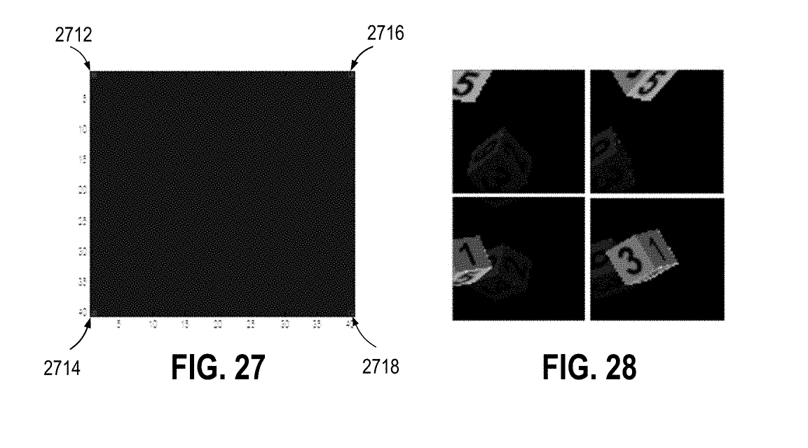

FIG. 25 is a display of an input orthographic light field image, and FIG. 26 is a zoomed-in view of the input orthographic light field image. The result of the illustrated visibility test determined that, in addition to the central view, the four corner views were needed as shown in FIG. 27 (which shows a reference view grid for four corners views 2712-2718) and FIG. 28 (which shows four reference images for four corners of a cube or die).

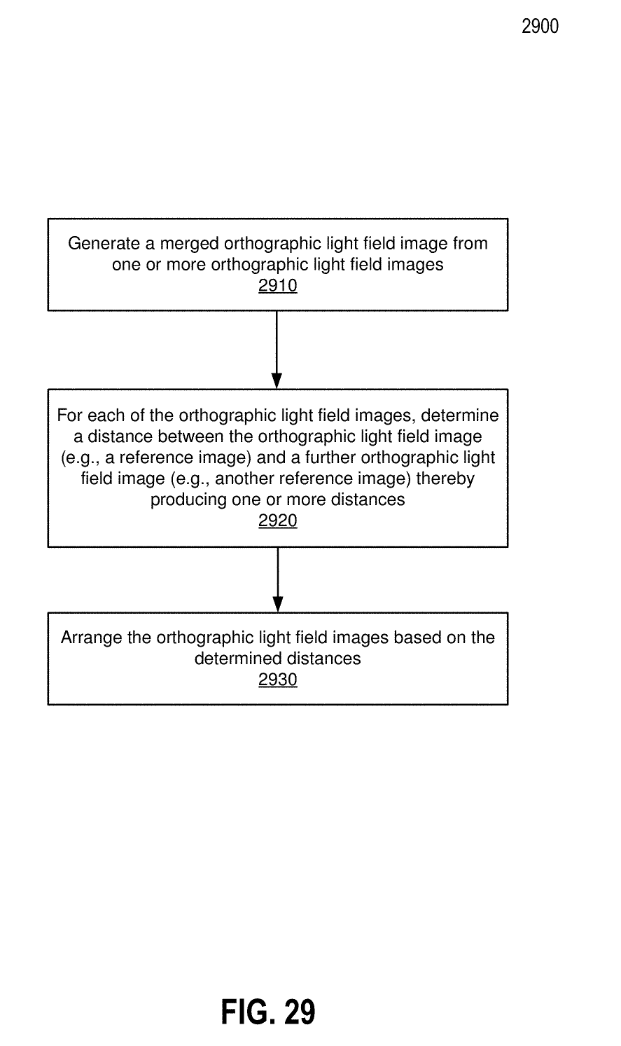

Based on the respective color map and disparity map, the reference images are converted into the new view position, and are then merged into a new orthographic image. Most common artifacts are caused by the projection of surfaces that are not correctly sampled according to the viewing angle. Since the artifacts for each image are different, distortion occurs after merging those images. To decrease the distortion, MR-DIBR applies the following steps (as described with respect to FIG. 29 below).

FIG. 29 is a flow diagram illustrating another method for rendering of a light field image according to one embodiment of the invention. Process 2900 may be performed by processing logic that includes hardware (e.g. circuitry, dedicated logic, etc.), software (e.g., embodied on a non-transitory computer readable medium), or a combination thereof. For example, process 2900 may be performed by rendering unit 1020 of FIG. 10.

Referring to FIG. 29, at block 2910, the processing logic generates a merged orthographic light field image from one or more orthographic light field images (as previously described). At block 2920, for each of the orthographic light field images, the processing logic determining a distance between the orthographic light field image (e.g., a reference image) and a further orthographic light field image (e.g., another reference image) thereby producing one or more distances. At block 2930, the processing logic arranges the orthographic light field images based on the determined distances. For example, in some embodiments for each of the orthographic light field images, beginning with a shortest distance to the target position to a furthest distance to the target position, the processing logic may switch the orthographic light field image with a next orthographic light field image if a difference between a candidate depth and a current depth is at least a predetermined depth threshold so as to replace the current depth and a color map of the merged orthographic light field image. In addition, the processing logic may fill cracks within the merged orthographic light field image (e.g., using an in-painting algorithm).

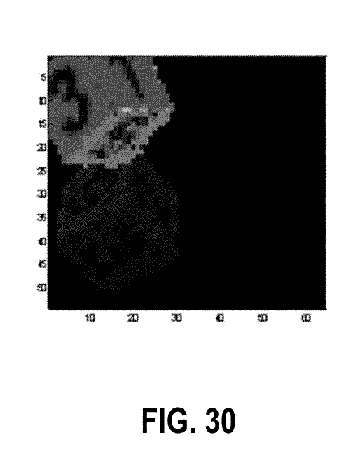

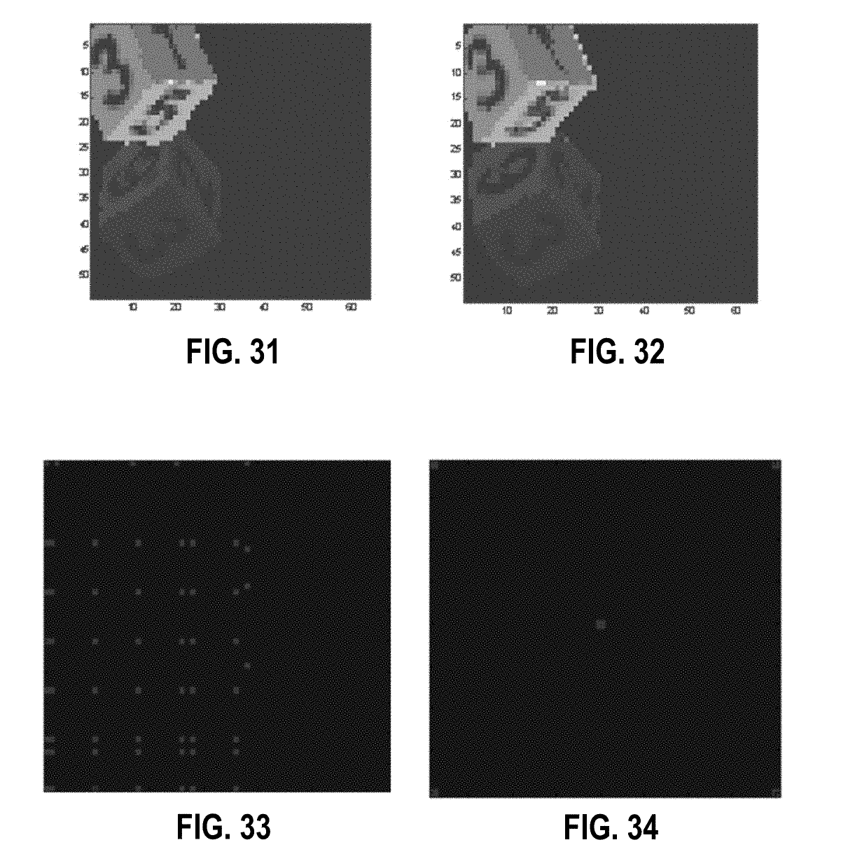

In some embodiments, however, it may be difficult to determine the appropriate depth threshold, which can be set based on neighboring disparities. In this regard, FIG. 31 shows a synthesized image where the four corners view is used with a depth threshold, which has improved quality over that of FIG. 30. Also, FIG. 32 shows a synthesized image using the four corners view and a central view, which improves the quality as well.

2.3 Comparison of Outputs of Two MR-DIBR Methods (Perspective and Orthographic)

To explore the difference between the two perspective and orthographic MR-DIBR methods of the invention, each are compared below in terms of compression ratio, PSNR, and SSIM.

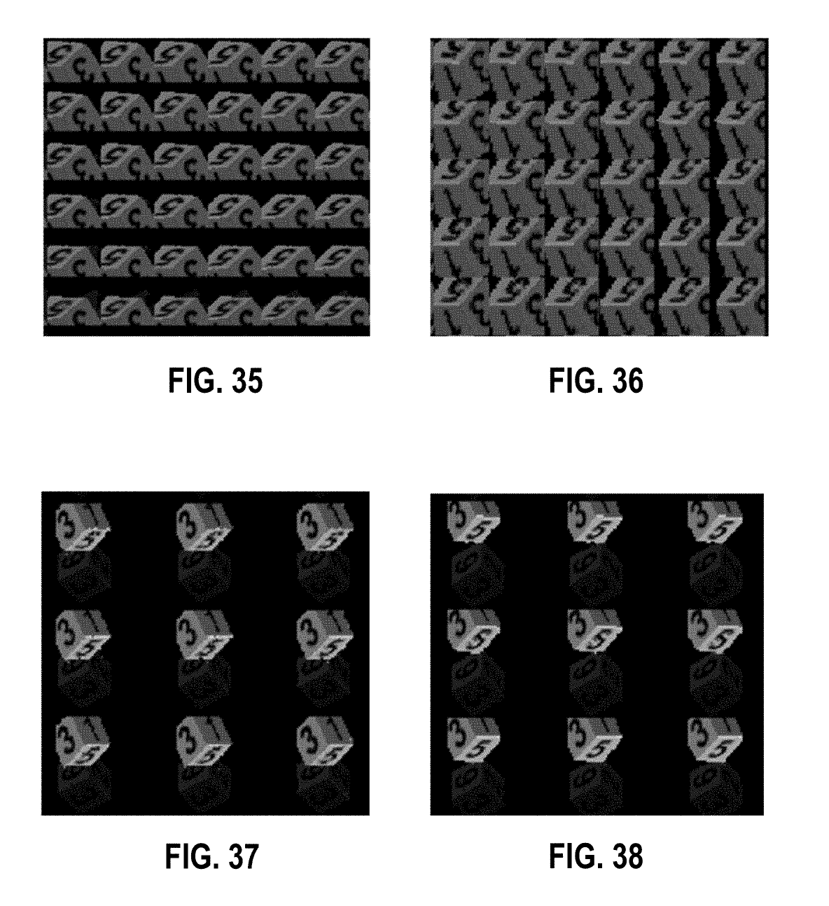

FIGS. 33 and 34 show the view grids of the perspective and orthographic MR-DIBR methods (as previously described). FIGS. 35-38 show the output images in different configurations from both methods. Regarding the compression ratio, the perspective camera is 57:1 while the orthographic camera is 320:1. In terms of quality of output image, the PSNR and SSIM are shown below in Table 6.

TABLE 6
PSNR and SSIM for Output Images Calculated Using the
Two Methods

| | MR-DIBR Method | | | |
|---|---|---|---|---|
| | Perspective (57:1) | | Orthographic (320:1) | |
| View | Perspective | Orthographic | Perspective | Orthographic |
| PSNR | 29.34 dB | 29.34 dB | 27.59 dB | 27.59 dB |
| SSIM | 0.9959 | 0.9972 | 0.9956 | 0.9970 |

As can be seen, the PSNR of the perspective method is slightly better than the orthographic method. Nevertheless, the compression ratio of the orthographic camera is much better. In terms of SSIM, there is little difference. Since the two objects are not far from the display screen, the compression ratio of the perspective method is not as high as the orthographic camera.

As is obvious from the above, in compression operations it is possible to select either an orthographic or perspective projection depending on which provides better compression performance. It is also possible to use both of these projection planes and improve the synthesized image quality. For example, the scene that is close to the display surface can use an orthographic projection and the scene that is farther form the display can use a perspective projection.

3. Depth Estimation

A depth map (or a disparity map) is the input data used for MR-DIBR. If the light field image is generated by a GPU, the associated depth map can be generated accurately by the GPU using suitable software. On the other hand, for images captured by commercially available light field cameras or camera arrays, a user must create the associated disparity map using disparity estimation methods.

3.1 Introduction of Depth Estimation

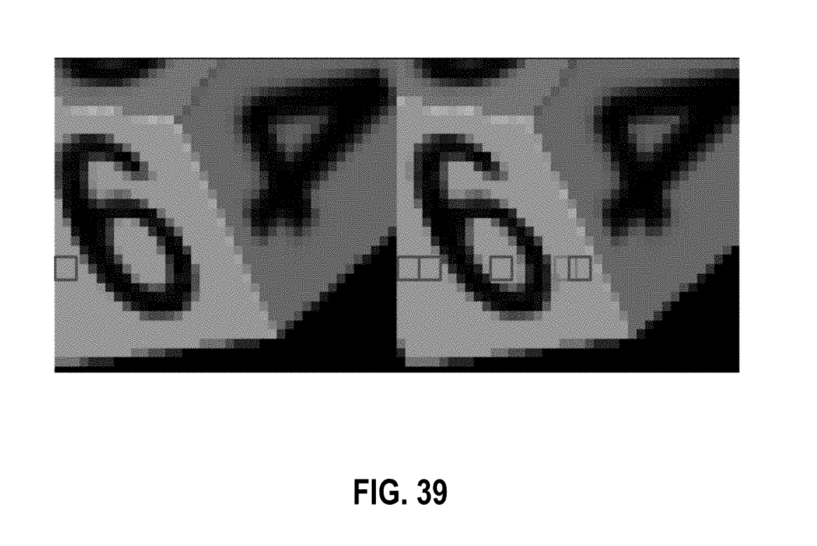

For two elemental images, there are many available algorithms to perform stereo matching and depth estimation. These functions can be found for instance in the computer vision toolbox in Matlab or in the library in OpenCV. For light field images, the size of each elemental image is very small and total number of hogels is very large. If stereo matching is used between two elemental images, it has two limitations. First, the small size of each image means there are limited features to be compared. Traditional stereo matching only compares two images. When the texture of an object is simple or the size of block is small, there may be multiple matching blocks on the neighboring image. FIG. 39 is an example illustrating multiple matching blocks within an image. Second, if the depth estimation is only based on two images, all other information is lost, which information could have been be used for improving the accuracy of the estimation.

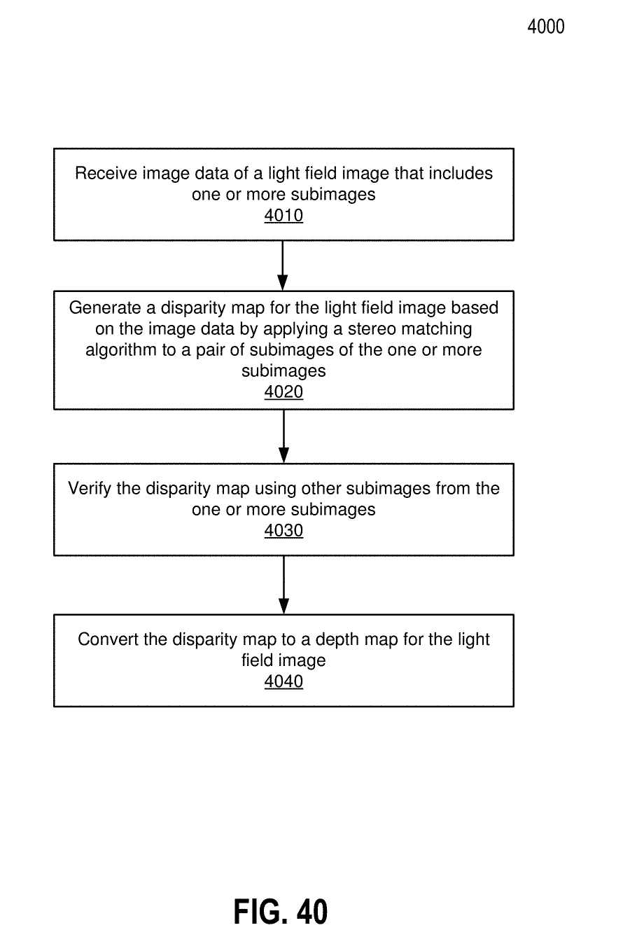

FIG. 40 is a flow diagram illustrating a method for depth estimation according to one embodiment of the invention. Process 4000 may be performed by processing logic that includes hardware (e.g. circuitry, dedicated logic, etc.), software (e.g., embodied on a non-transitory computer readable medium), or a combination thereof. For example, process 4000 may be performed by pre-processor 1010 of FIG. 10.

In addition, process 4000 may identify matching blocks among the nearest neighboring elemental images, then verify the disparity by matching these blocks with elemental images that are on the same horizontal or vertical line but farther away.

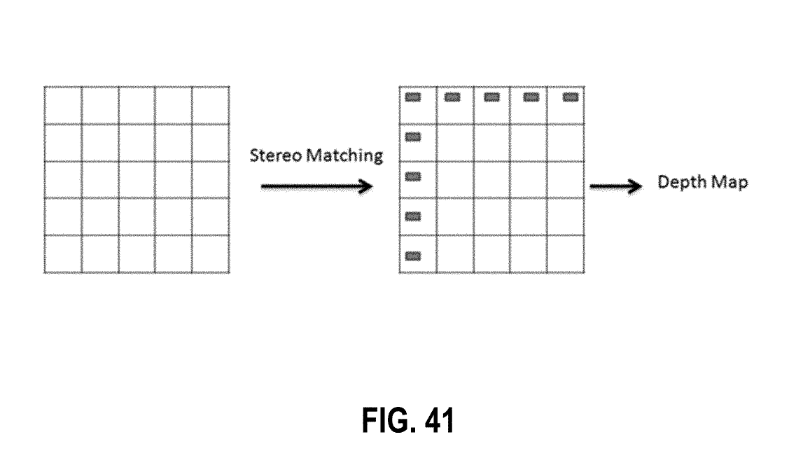

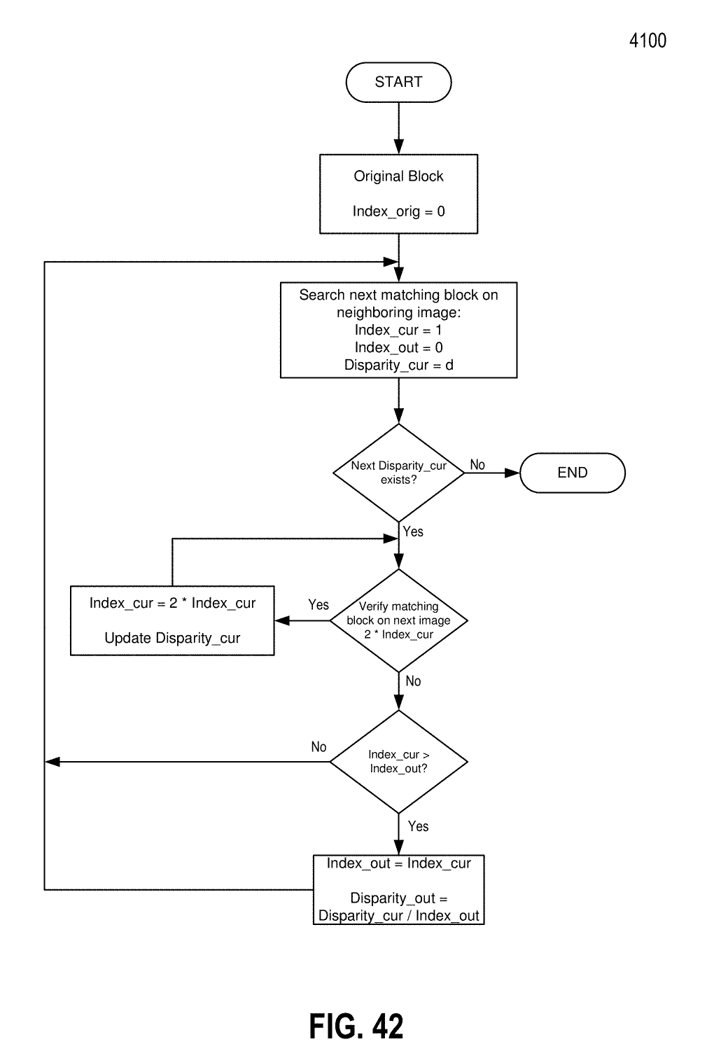

Referring to FIG. 40, at block 4010, the processing logic receives image data of a light field image that includes one or more subimages At block 4020, the processing logic generates a disparity map for the light field image based on the image data by applying a stereo matching algorithm to a pair of subimages of the one or more subimages. In one embodiment, for horizontal disparity, elemental images on the same row may be utilized for stereo matching. Similarly, elemental images on the same column may be used for vertical disparity. See, e.g., FIG. 41 (which illustrates a horizontal disparity map of an elemental image and a conversion of a disparity map to a depth map), and FIG. 42 (which is a flow diagram illustrating a method for depth estimation of one or more light field images).

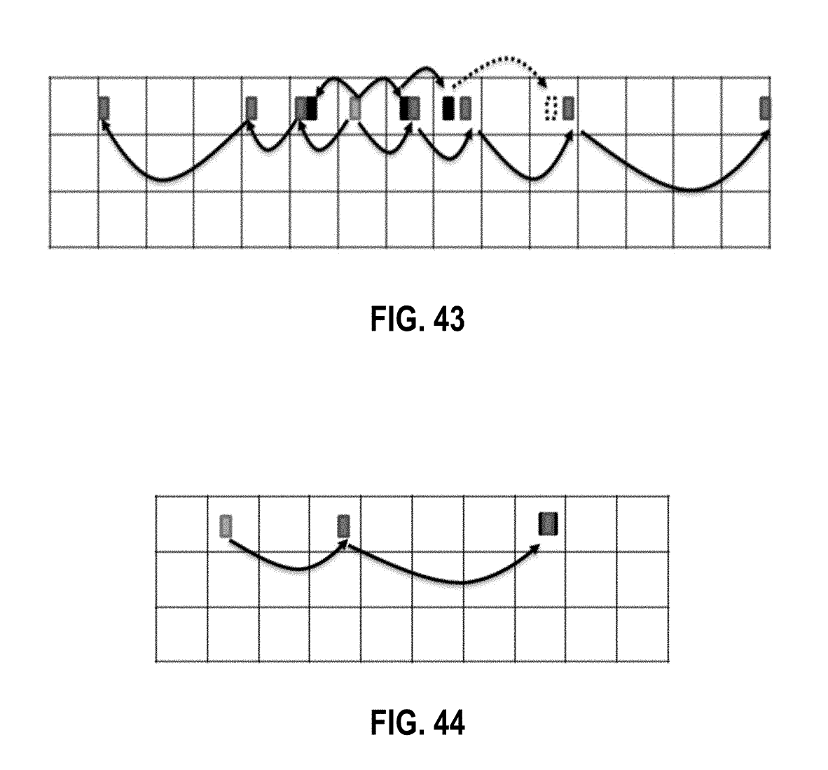

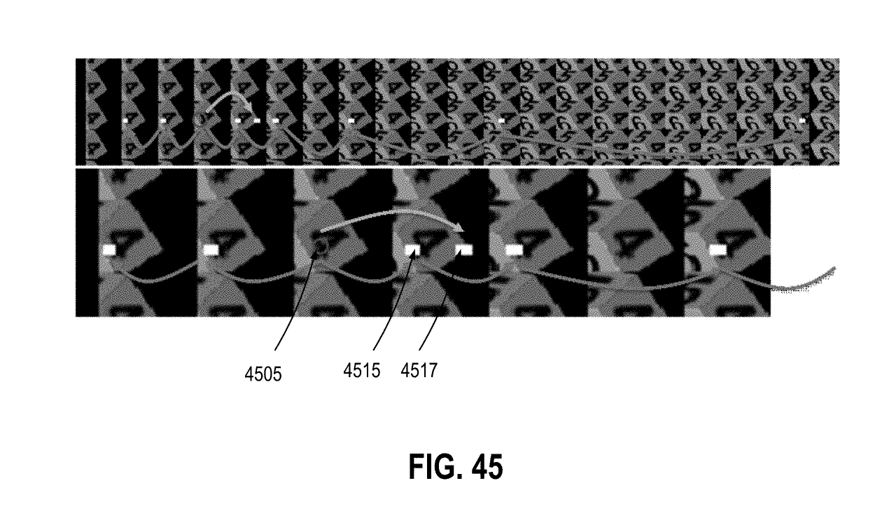

Referring back to FIG. 40, at block 4030, the processing logic verifies the disparity map using other subimages from the one or more subimages. For example, verifying matching blocks by all possible elemental images on the same row or column can improve the accuracy of disparity values, but increases runtime significantly. Using a power of 2 search, for example, can ensure the accuracy within the minimum runtime. The power of 2 search algorithm checks for a block match in two elemental images (EIs) away, four EIs away, eight EIs away, etc. The runtime then decreases from O(n) to O(log n). Searching bi-directionally (i.e., in two directions) improves the accuracy of estimation as well (see, e.g., FIGS. 43 and 45). When the block is searched in the positive direction, it is expected to move right and when the block is searched in the negative direction, it's expected to move left. Due to sampling error, a matching block may be found within ±1 pixel of the expected location, therefore the power of 2 search method also looks at ±1 pixel area in the horizontal and vertical directions to verify the block match (and disparity), see, e.g., FIG. 44 (which is an example illustrating a power-of-2 search technique with a one pixel shift). Turning back again to FIG. 40, at block 4040, the processing logic converts the disparity map to a depth map for the light field image.

FIG. 45 illustrates application of the bi-directional search technique on a test image. In FIG. 45, circle 4505 is the block that is being matched in two directions. On the right, the matching starts with two matching blocks 4515 and 4517 on the right-neighbor elemental image. Only one of the two blocks continues to have a match on the right and it is selected as the actual match. On the left, the match is identified in two EIs. On the left, the furthest match is identified at an EI that is two EIs to the left of the circle and on the right the furthest match is 16 EIs to the right of the circle. The disparity at the left-most matched EI is −3 and the disparity at the right-most matched EI is +23. Based on these results, the final disparity for the pixel is identified by the circle with the following formula:

Disparity=(right disparity−left disparity)/(right EI distance−left EI distance)

Therefore, disparity=(23−(−3))/(16−(−2))=26/18=1.44.

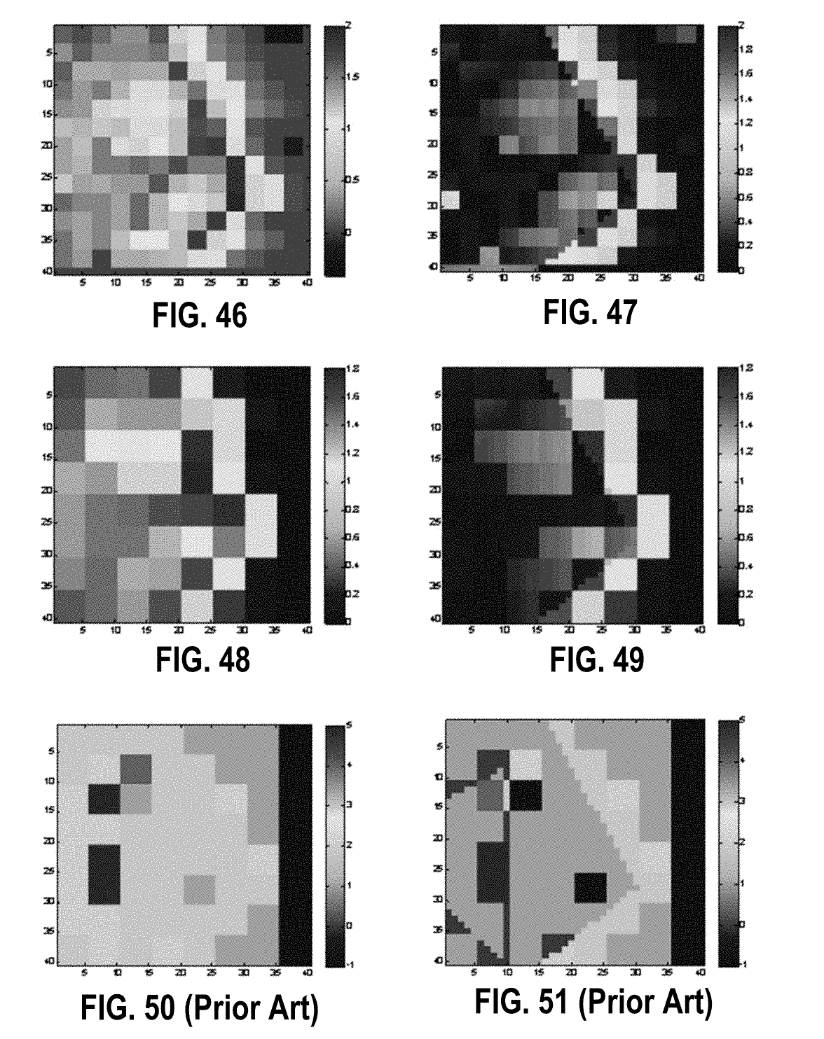

With reference to FIGS. 46-51, the output of the depth maps with different block sizes are shown in. For example, when the block size is 3×3 (FIGS. 46-47), the average error is 0.41 pixel. When the block size is 5×5 (FIGS. 48-49), the average error is 0.36 pixel. Both are less than 0.5 pixel, which cannot be achieved by prior art methods, which compare between only two elemental images. FIG. 51 shows the output result based on the cross-correlation coefficient method, whose error is around 1.38 pixels.

3.2 Errors at Object Boundary

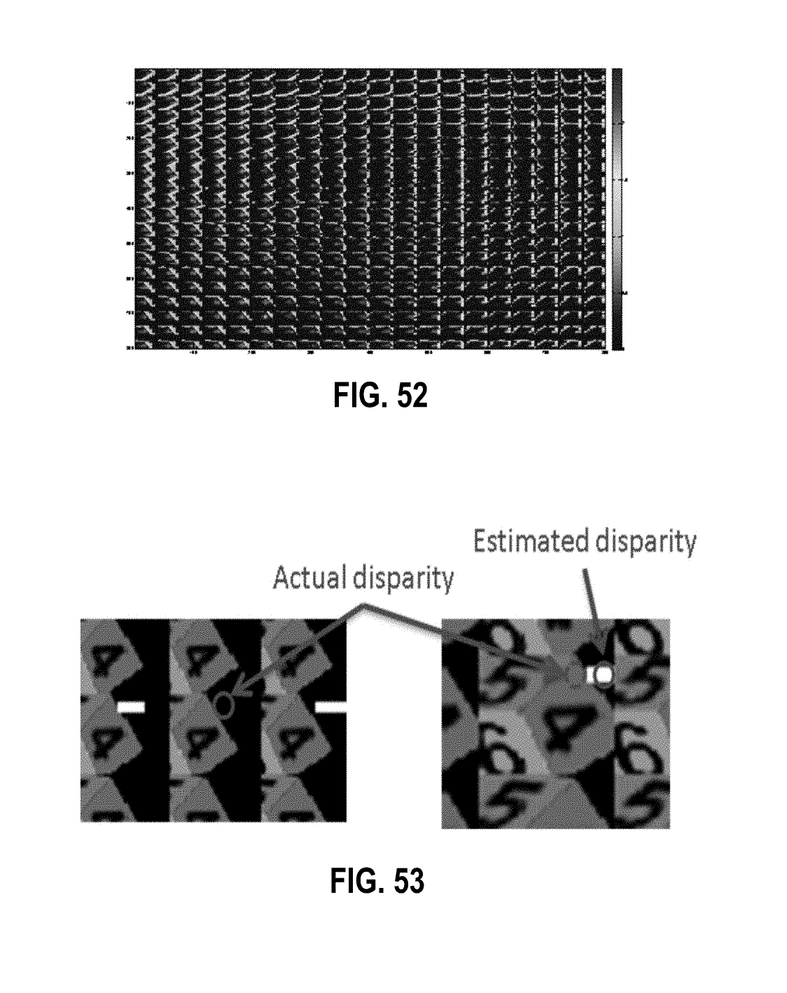

In the non-limiting illustrated example herein, 54×64 hogel images are used as input images, then the disparity map is computed for the central 20×20 hogels—FIG. 52 shows the disparity map for these 20×20 hogels. The average error for the above disparity map is 0.30 pixel. As seen from FIG. 52, the error is mostly distributed near the boundary of the object.

When the background is close to the boundary of an object, the background is typically occluded by the object. Since the texture of the background is only black, the method may give a false positive and detect the background as a matching block, see, e.g., FIG. 53. This issue is resolved by use of background detection (as discussed herein below).

3.3 Object Identification and Segmentation on Depth Map

The visibility test requires a bounding box of the objects in the scene as its main input and a method to determine the bounding boxes of the objects in each frame of a light field video is described below. The method, for example, finds a bounding box that has a face parallel to a display surface. To estimate the position of the bounding box, the depth map of the light field image is used and the central pixel taken from each hogel of the light field depth map. This defines the extreme locations of the bounding box of an object that is parallel to the display surface (see e.g., Table 7, FIGS. 5 and 7).

TABLE 7
Parameters for Single Die Model
Die Parameter

| | Model Position | | | Model Look-At | | | Model Up | | | | | |
|---|---|---|---|---|---|---|---|---|---|---|---|---|
| | (mm) | | | Vector | | | Vector | | | Scale Factor | | |
| | x | y | z | x | y | Z | x | y | z | x | y | z |
| Die 1 | 0 | 0 | 20 | .577 | .577 | .577 | 0 | 1 | 0 | 8 | 8 | 8 |

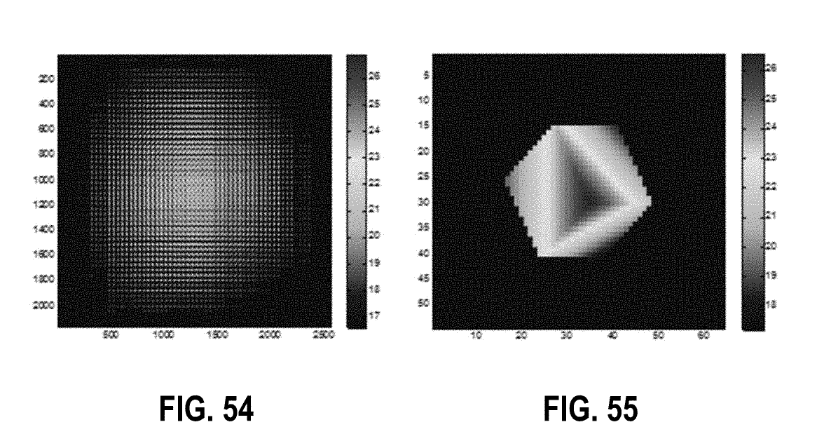

FIG. 54 (which shows an input light field depth map of a single die model) and FIG. 55 (which shows central pixels from hogels of the single die model's depth map). Based on FIG. 55, the estimated bounding box has the following coordinates Xmin=−6.6 mm, Xmax=6.6 mm, Ymin=−5.8 mm, Ymax=5.4 mm. Zmin=16.6248 mm. When the number of objects in the scene increases, several methods can be used to estimate the bounding box(es) as shown in Table 8.

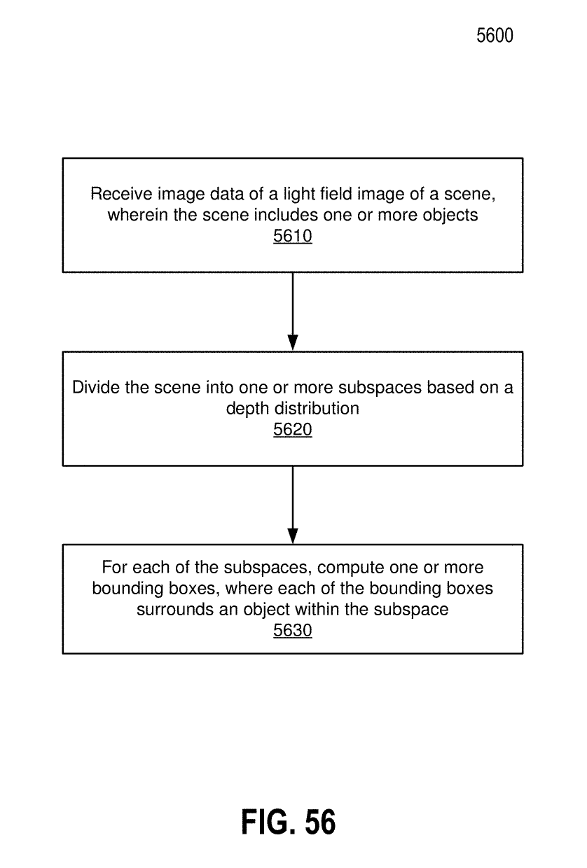

FIG. 56 is a flow diagram illustrating a method for bounding box estimation according to one embodiment of the invention. Process 5600 may be performed by processing logic that includes hardware (e.g. circuitry, dedicated logic, etc.), software (e.g., embodied on a non-transitory computer readable medium), or a combination thereof. For example, process 5600 may be performed by pre-processor 1010 of FIG. 10.

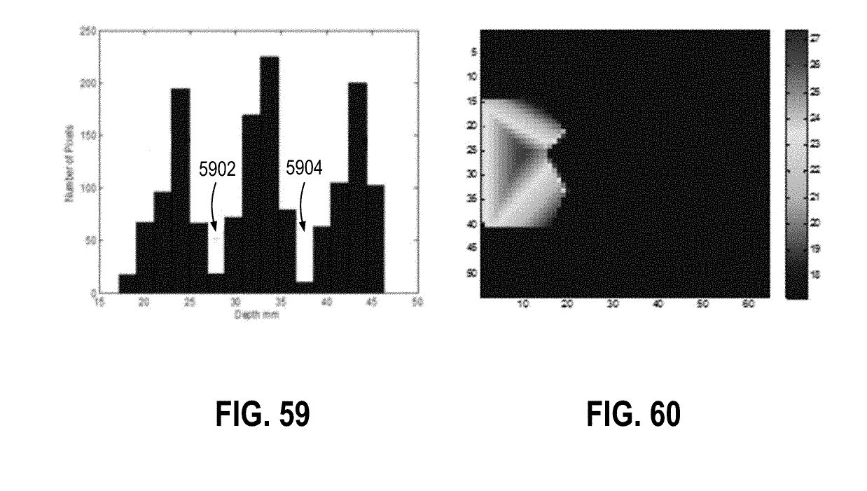

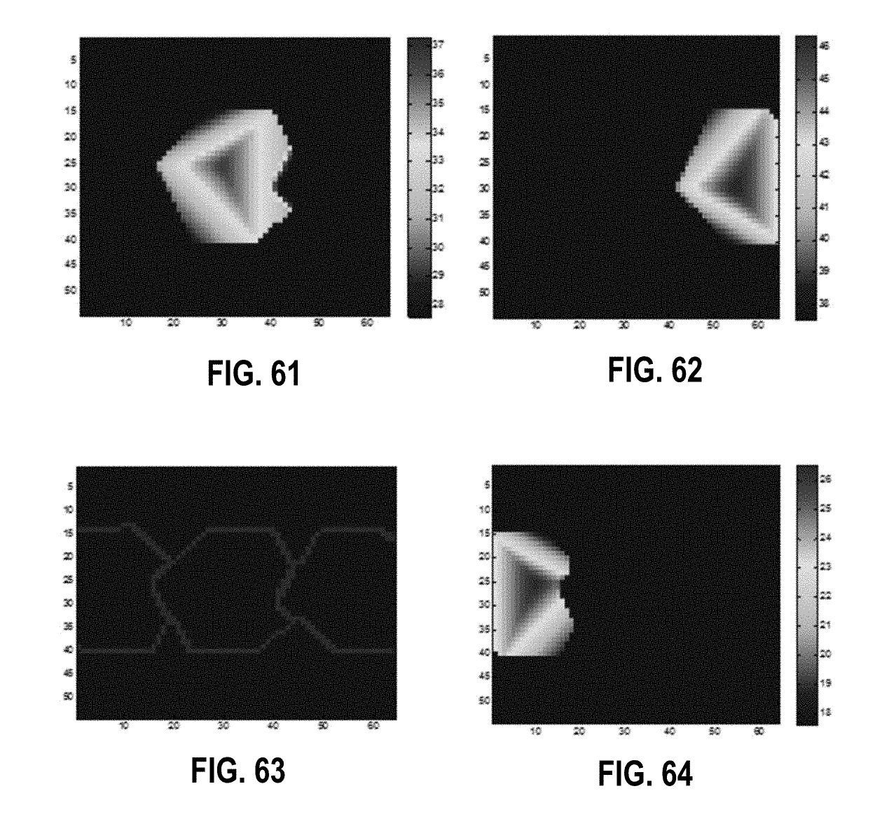

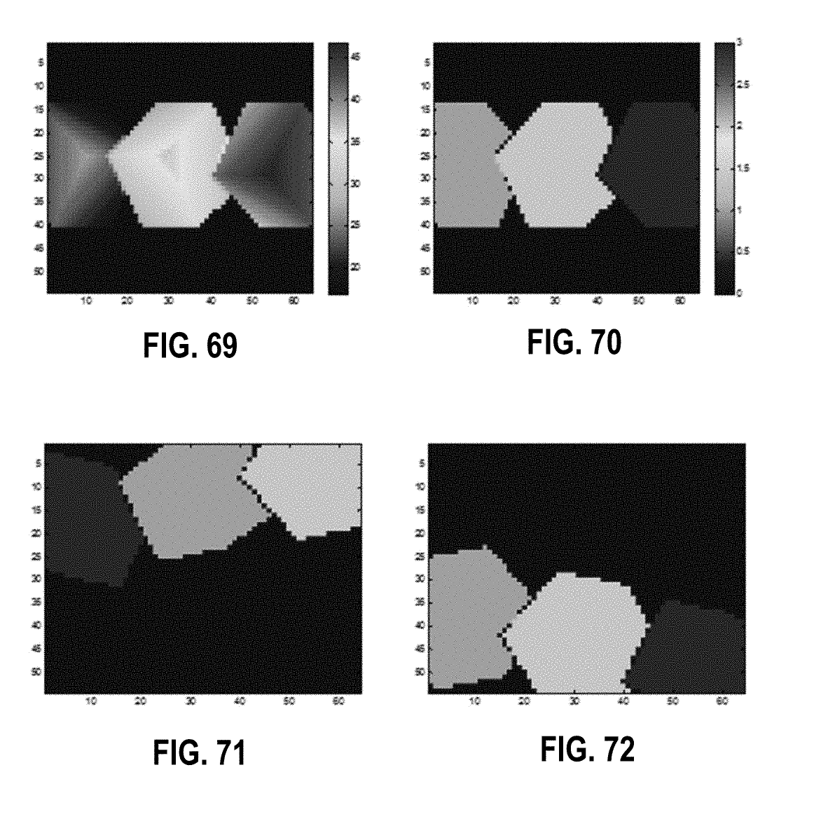

Referring to FIG. 56, at block 5610, the processing logic receives image data of a light field image of a scene, where the scene includes one or more objects. At block 5620, the processing logic divides a scene into one or more subspaces based on a depth distribution. For example, bounding boxes of the objects in the scene is one of the primary inputs of the visibility test (as previously described). One of the methods for calculating the bounding boxes is the depth distribution method. This method calculates the bounding box of the objects depending on the depth distribution in the scene, for example, using a histogram (see, e.g., FIG. 59) of the disparity map (or depth map), see, e.g., FIG. 69. Subsequently, cluster analysis may be utilized to identify disparity (or depth) clusters in the histogram. The disparity (or depth) clusters are generally separated by certain thresholds (e.g., thresholds 5902 and 5904 of FIG. 59). For example, if a depth is less than 30 mm then the object belongs to a first cluster, which may be used to determine a first subspace (see, e.g., FIG. 60). If the depth is between 30 and 40 mm then object belongs to a second cluster, which may be used to determine a second subspace (see, e.g., FIG. 61). If the depth is more than 40 mm the object belongs to a third cluster, which may be used to determine a third subspace (see, e.g., FIG. 62). Each cluster identifies a part of a scene where a bounding box can exist. The bounding box in each cluster is found by determining extreme coordinates of the objects within each cluster, for example, Xmin, Xmax, Ymin, Ymax, Zmin and Zmax. At block 5630, for each of the subspaces, the processing logic computes one or more bounding boxes, where each of the bounding boxes surrounds an object within the subspace.

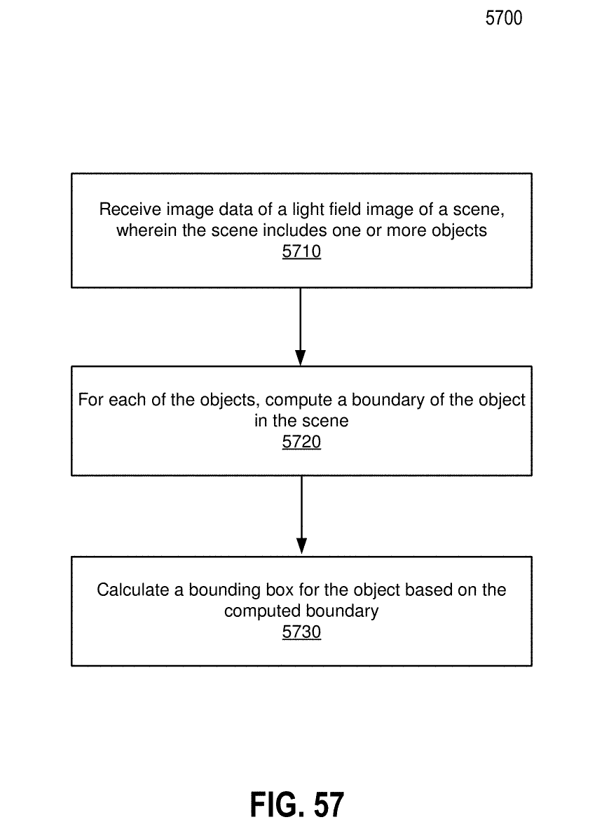

FIG. 57 is a flow diagram illustrating another method for bounding box estimation according to one embodiment of the invention. Process 5700 may be performed by processing logic that includes hardware (e.g. circuitry, dedicated logic, etc.), software (e.g., embodied on a non-transitory computer readable medium), or a combination thereof. For example, process 5700 may be performed by pre-processor 1010 of FIG. 10.

Referring to FIG. 57, at block 5710, the processing logic receives image data of a light field image of a scene, where the scene includes one or more objects. At block 5720, for each of the objects, the processing logic computes a boundary of the object in the scene (e.g., using a gradient map). At block 5730, the processing logic calculates a bounding box for the object based on the computed boundary.

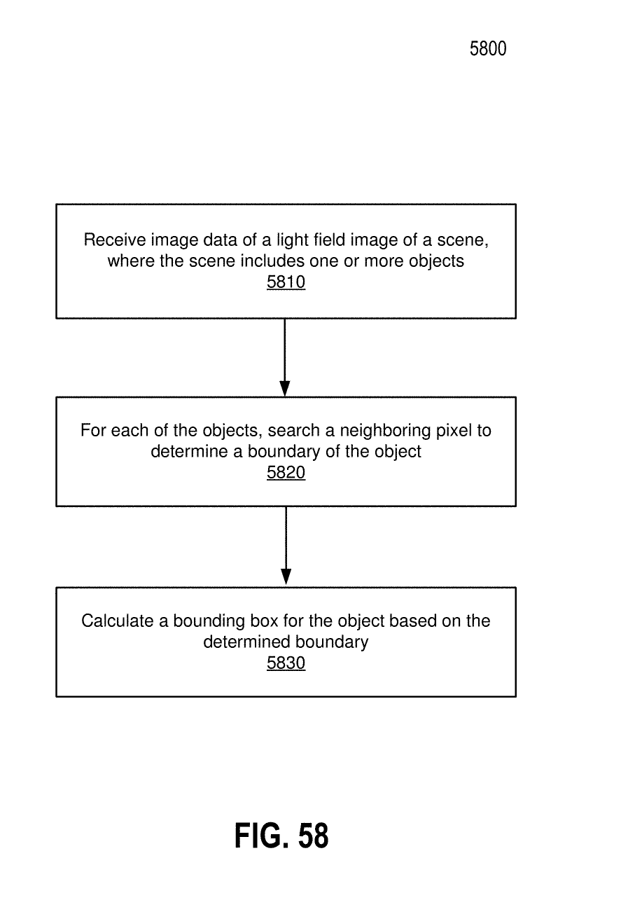

FIG. 58 is a flow diagram illustrating another method for bounding box estimation according to one embodiment of the invention. Process 5800 may be performed by processing logic that includes hardware (e.g. circuitry, dedicated logic, etc.), software (e.g., embodied on a non-transitory computer readable medium), or a combination thereof. For example, process 5800 may be performed by pre-processor 1010 of FIG. 10.

Referring to FIG. 58, at block 5810, the processing logic receives image data of a light field image of a scene, where the scene includes one or more objects. At block 5820, for each of the objects, the processing logic searches a neighboring pixel to determine a boundary of the object. At block 5830, the processing logic calculates a bounding box for the object based on the determined boundary.

In the example discussed herein below, a three-dice testing model is shown. Table 8 shows the parameters for the model, and Table 9 shows the actual bounding boxes for the three-dice model.

TABLE 8
Parameters for the Three Dice Model
Dice Parameters

| | Model Position | | | Model Look-At | | | Model Up | | | | | |
|---|---|---|---|---|---|---|---|---|---|---|---|---|
| | (mm) | | | Vector | | | Vector | | | Scale Factor | | |
| | X | y | z | x | y | z | x | y | z | x | y | z |
| Die 1 | −10 | 0 | 20 | .577 | −.577 | .577 | 0 | 1 | 0 | 8 | 8 | 8 |
| Die 2 | 0 | 0 | 30 | .577 | .577 | −.577 | 0 | 1 | 0 | 8 | 8 | 8 |
| Die 3 | 10 | 0 | 40 | −.577 | .577 | .577 | 0 | 1 | 0 | 8 | 8 | 8 |

TABLE 9
Actual Bounding Boxes for the Three Dice Model
Bounding Box (mm)

| Subspace | Xmin | Ymin | Zmin | Xmax | Ymax |
|---|---|---|---|---|---|
| 1st | −16.8 | −5.7 | 17.2 | −3.2 | 5.7 |
| 2nd | −6.8 | −5.7 | 27.2 | 6.8 | 5.7 |
| 3rd | 3.2 | −5.7 | 37.2 | 16.8 | 5.7 |

TABLE 10
Estimated bounding boxes using the Method of FIG. 56
Estimated Bounding Box (mm)

| Subspace | Xmin | Ymin | Zmin | Xmax | Ymax |
|---|---|---|---|---|---|
| 1st | −13 | −5.4 | 16.7 | −4.6 | 5.4 |
| 2nd | −7 | −5.4 | 27.6 | 5 | 5.4 |
| 3rd | 3.4 | −5.4 | 37.6 | 13 | 5.4 |

From Table 10 above, the bounding boxes are overlapped among different subspaces, which can be solved by overlap detection. See, e.g., FIGS. 60-62 for the different subspaces. As shown on FIG. 59, when the gap of depth is very small among objects, finding an optimal threshold (e.g., threshold 5902 and threshold 5904) value is crucial. If the two objects have the same depth value, it is impossible to divide them by a threshold value via the method of FIG. 56. As such, the methods of FIGS. 57-58 are more appropriate when this issue is faced.

TABLE 11
Estimated Bounding Boxes using the Method of FIG. 57
Estimated Bounding Box (mm)

| Subspace | Xmin | Ymin | Zmin | Xmax | Ymax |
|---|---|---|---|---|---|
| 1st | −13 | −5.4 | 16.7 | −5.4 | 5.8 |
| 2nd | −6.6 | −5.4 | 27.6 | 4.6 | 5.4 |
| 3rd | 3.4 | −5.4 | 37.6 | 13 | 5.4 |

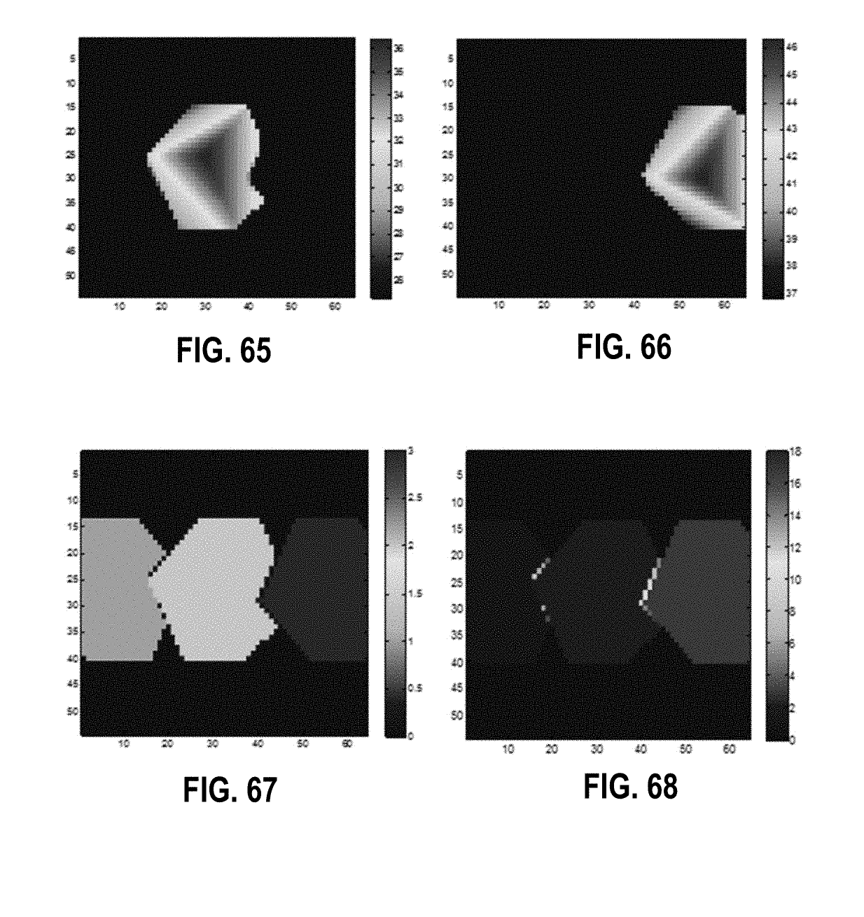

The method of FIG. 57 does not select the pixels on the boundary. See, e.g., FIG. 63 for the computed (or detected) boundary by performing a gradient operation on the depth map. FIGS. 64-66 show the different subspaces with respect to the method of FIG. 57. An additional hogel is added on each estimated bounding box, which results in the method of FIG. 58 (see, e.g., Table 12, FIG. 67).

TABLE 12
Estimated Bounding Boxes using the Method of FIG. 58
Estimated Bounding Box (mm)

| Object | Xmin | Ymin | Zmin | Xmax | Ymax |
|---|---|---|---|---|---|
| 1st | −13 | −5.4 | 16.7 | −5.4 | 5.8 |
| 2nd | −6.6 | −5.4 | 27.6 | 4.6 | 5.4 |
| 3rd | 3.4 | −5.4 | 37.6 | 13 | 5.4 |

Without computing the boundary, the nearest neighbor search needs less runtime than the method of FIG. 57. Nevertheless, due to the sample error on the boundary (see, e.g., FIG. 68), there may be some small objects on the boundary.

Due to the occlusion, it is beneficial to check the side views. The bounding boxes are computed on each view and then combined with the bounding boxes from those views. Considering there is a shift from the side view, the relative shift added, where Relative Shift=Depth*tan(FOV/2).

TABLE 13
Combined Bounding Boxes from All Views

| | Object | Xmin | Xmax | Ymin | Ymax | Zmin |
|---|---|---|---|---|---|---|
| Right View | 1st | −16.5 | −4.3 | −5 | 5.4 | 17.1 |
| | 2nd | −6.7 | 5.6 | −5 | 5.4 | 27.2 |
| Top View | 1st | −6.6 | 5.4 | −5.6 | 4.4 | 27.7 |
| | 2nd | 3.4 | 12.6 | −5.7 | 1.7 | 37 |
| | 3rd | −12.6 | −5 | −5.6 | 5.3 | 17.4 |
| Left View | 1st | −8.6 | −6.4 | 2.2 | 5.4 | 16.9 |
| | 2nd | −5.7 | 4 | −5 | 5.4 | 27.4 |
| | 3rd | 3.8 | 16.5 | −5 | 5.4 | 37.2 |
| | 4th | −8.1 | −6.1 | −5.4 | −0.6 | 18.1 |
| Bottom View | 1st | −6.6 | 5.4 | −5.6 | 4.4 | 27.7 |
| | 2nd | 3.4 | 12.6 | −5.7 | 1.7 | 37 |
| | 3rd | −12.6 | −5 | −5.6 | 5.3 | 17.4 |
| Synthesized Box | 1st | −16.5 | −5.6 | 16.7 | −4.3 | 5.8 |
| | 2nd | −6.7 | −5.7 | 27.2 | 5.6 | 5.4 |
| | 3rd | 3.4 | −5.6 | 37.6 | 13 | 5.4 |

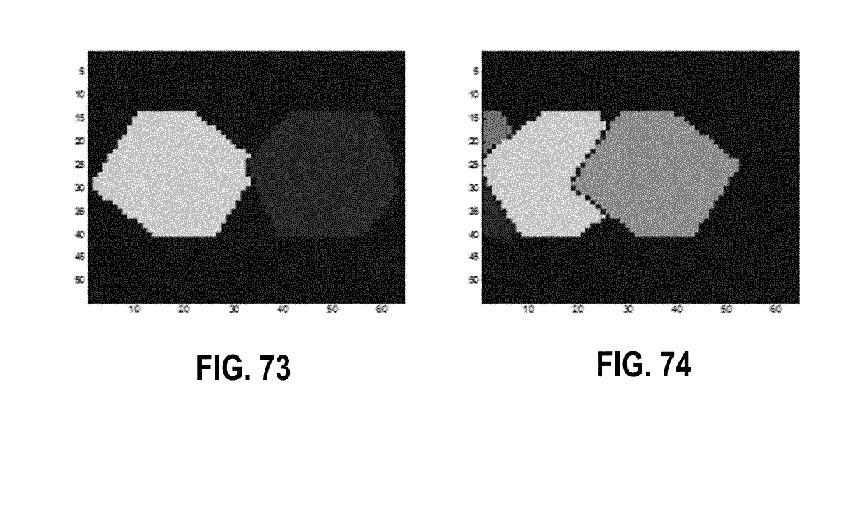

Using the bounding boxes from different views can beneficially reduce the effects of occlusion. When one view shows a single bounding box, another view may show multiple bounding boxes (see, e.g., FIGS. 70-73). For example, in FIG. 69 one sees a single bounding box, while in FIG. 74, the left-most die is divided into two sub-parts. Therefore, while the method is identifying all possible bounding boxes in the scene, it is important to look at the scene from different views. When synthesizing different views, the user should first identify the bounding boxes in different views and then create a synthesized bounding box for each object in the scene.

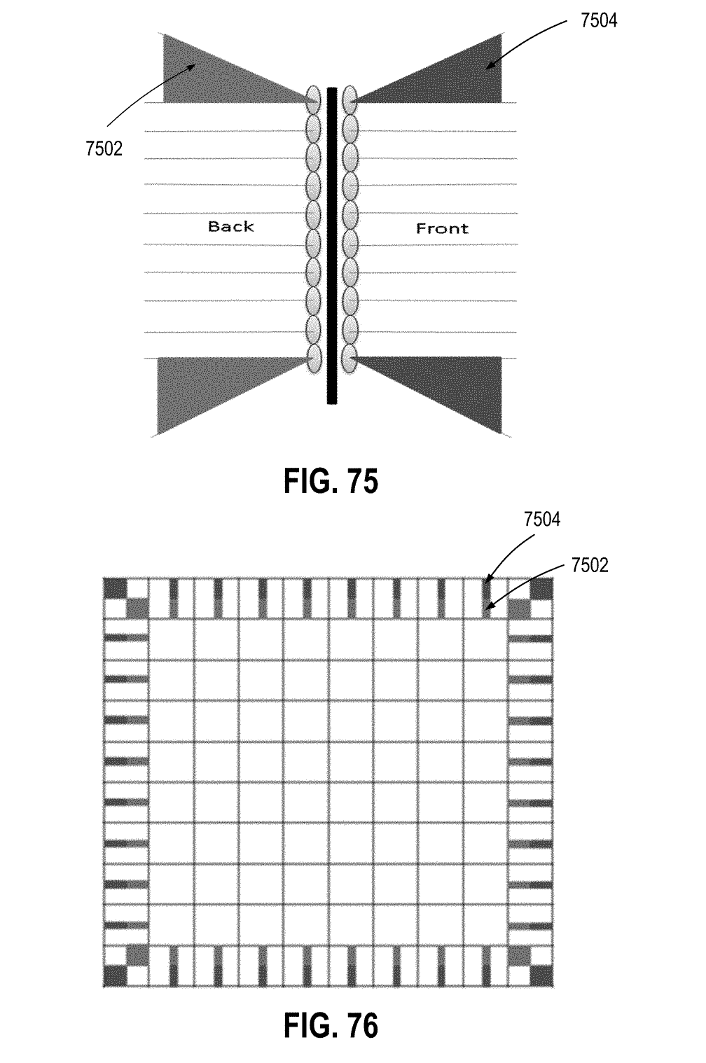

The elemental images on the edge of the display can be used for searching the objects that are outside the display boundary. For MR-DIBR based on a perspective camera, the minimum depth can determine the density of a view grid. To find the starting and ending index of the view grid, the non-empty area is searched for each central line, which is shown by areas 7502 and 7504 on FIGS. 75-76.

3.4 Visibility Test Performed on a Light Field Image Without a Separate Depth Map

As previously described, in order to generate the necessary input for the visibility test, the light field image is processed in the following steps:

1. Depth estimation,

2. Bounding boxes estimation, and

3. Visibility test.

TABLE 14
Input Test Light Field Image

| Image 1 | | | Image 2 | | |
|---|---|---|---|---|---|
| | Hogel | | | Hogel | |
| Image Size | Size | Anglet | Image Size | Size | Anglet |
| 2160 × 2560 | 40 × 40 | 54 × 64 | 2160 × 2560 | 80 × 80 | 27 × 32 |

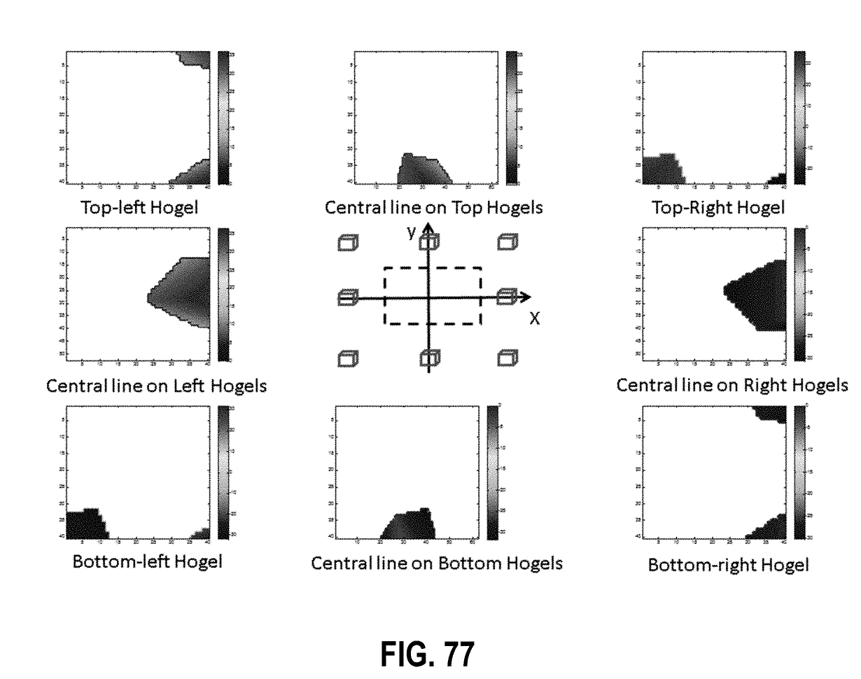

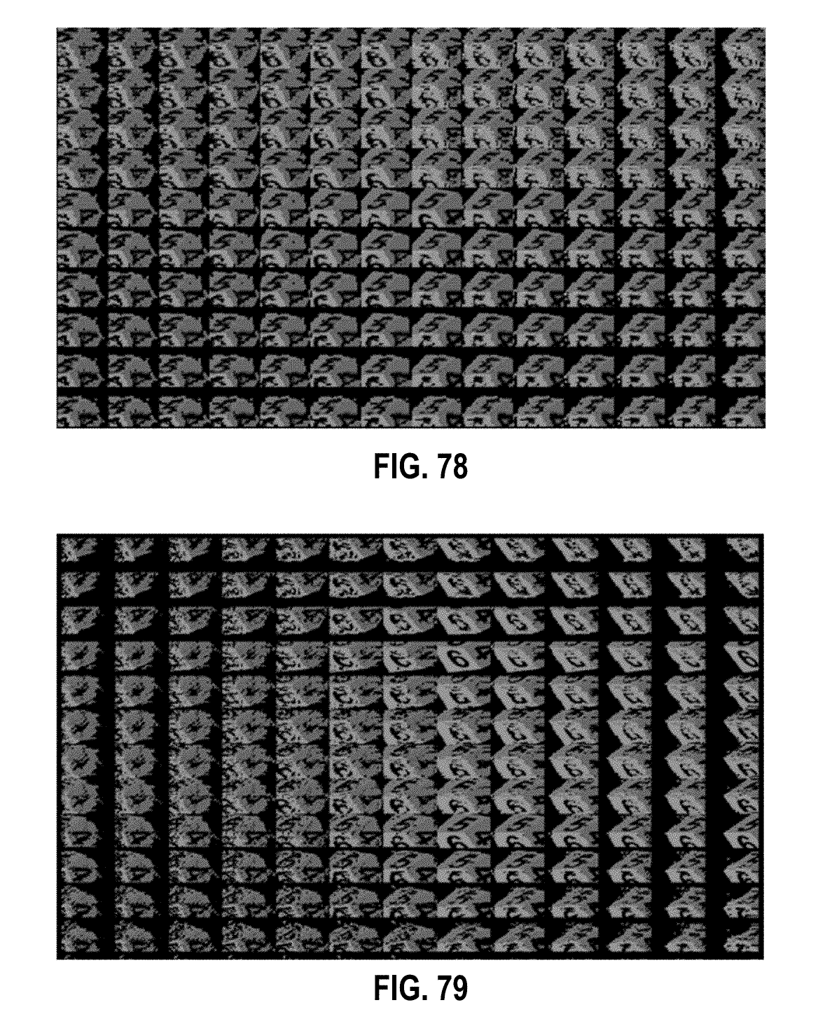

FIG. 77 illustrates multiple views from different hogels, and FIGS. 78-79 show output images from a colormap only. To reduce the error near the boundary of the cubic, background detection is applied on each cubic. Currently, the quality of the output is not good as a result of the error from the estimated depth map though there exist technologies such as deep learning can be applied for depth estimation, which, after improving the accuracy of depth map, the output images are improved.

4. Ray Transform-Based Rendering

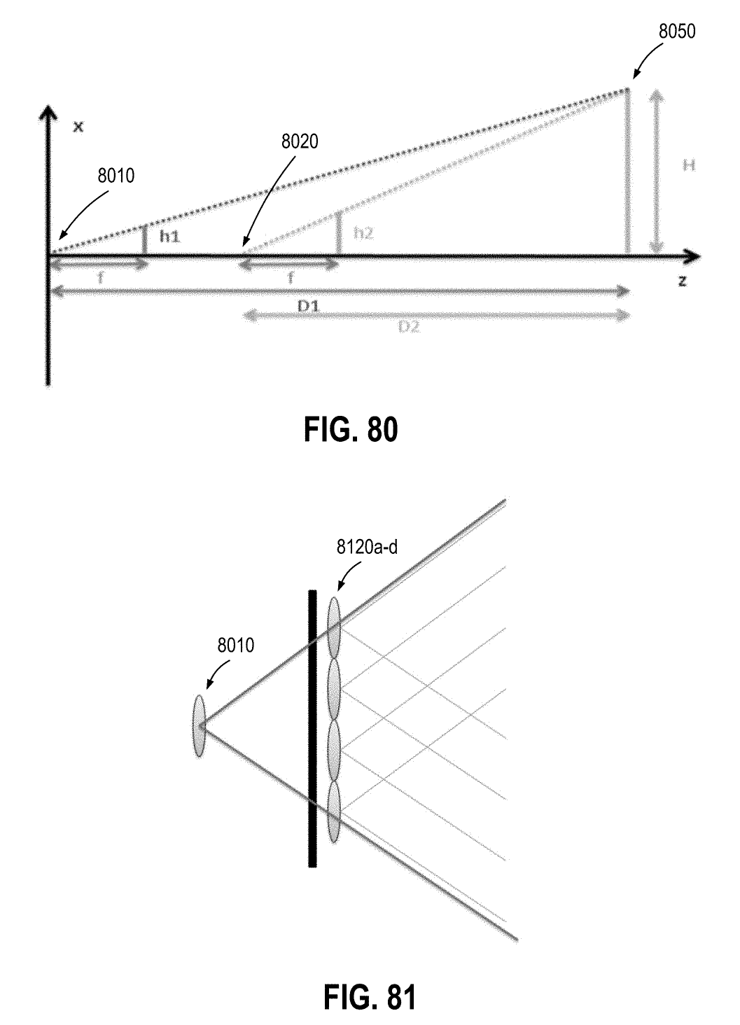

Ray transform is a method that renders new images based on the location of the camera. When a fixed FOV camera moves farther from a scene, it covers more of the scene but records less of the details. Knowing this, compression algorithms can be adjusted so that some of the cameras are placed farther from the scene to record more general information and some of the cameras are placed closer to the scene to record the areas that require additional details. The concept of ray transform is used to create less-detailed views of multiple close up cameras by using a single camera that is placed farther from the scene. The FOV of the cameras does not have to be the same for this method to work as shown in FIG. 80.

4.1 Equation of Ray Transform:

FIG. 80 shows a ray transform projection for two cameras. In FIG. 80, camera 8010 is placed farther from the scene, while camera 8020 is placed closer to the scene. Both cameras 8010 and 8020 have the same focal length (f), but have different FOVs. In the illustrated embodiment, it is assumed camera 8010 is the reference camera, and camera 8020 is the synthesized camera.

As depicted in FIG. 80, camera 8010 is placed at distance D1 away from object 8050 and camera 8020 is placed at distance D2 away from object 8050. Object height is H, recorded image height in camera 8010 is H1 and recorded image height in camera 8020 is H2. From similar triangles, one obtains:

$$\frac{H}{D 1} = \frac{h 1}{f} and \frac{H}{D 2} = \frac{h 2}{f}$$

then one gets:

$$\frac{h 1}{h 2} = \frac{D 2}{D 1}$$

This equation is used to find the relationship of the pixels between two cameras. If the synthesized camera's optical axis is not overlapping with the reference camera's optical axis, a shift is added to the formula above and one gets:

$$\frac{h 1}{h 2 + Shift} = \frac{D 2}{D 1}$$

The shift can be then added in both horizontal direction and vertical direction if necessary.

Saving Cameras.

FIG. 81 illustrates the FOV covered by the reference camera and other cameras. As the reference camera shifts farther from the object, the area it covers becomes larger. The relationship between the FOV and the distance is shown below:

$$CoveredArea = 2 \times DistanceOfObject \times tan ( \frac{F O V}{2} ) \qquad Equation 1$$

As shown in FIG. 81, reference camera 8010 can cover the FOV of four or more regular cameras 8120a-d, and include the camera plane in its coverage. By using just the reference camera, a user can reduce the number of cameras required to take pictures of the scene.

The position of the reference camera is flexible.

Moreover, a user can place the reference camera anywhere. There is no requirement to place the reference camera on the same plane or parallel to the optical axis of other cameras. Considering the position and the size of object, sometimes the covered area may be overlapped by different cameras. Redundant cameras can be ignored that can be reconstructed by other cameras.

As the distance between the reference camera and the rendered camera becomes larger, the resolution of reconstructed image decreases. To ensure the resolution of the rendered image, the farther reference camera may be configured to have a higher resolution.

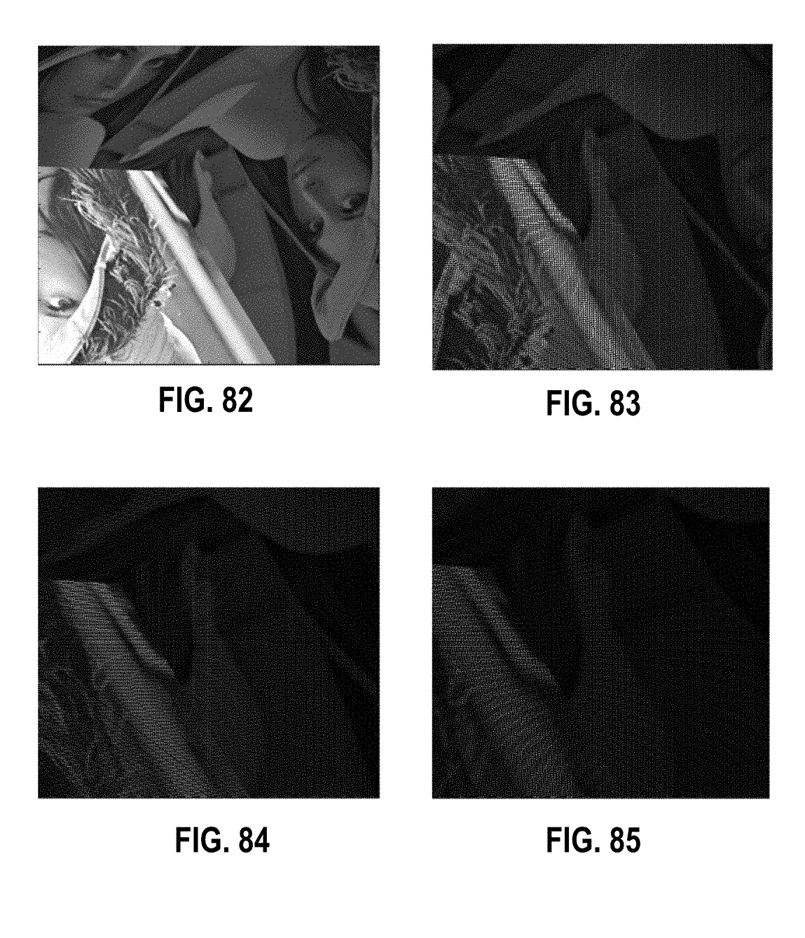

FIG. 82 shows a reference image, and FIGS. 83-85 show the rendered image with different depths. The resolution of the reference image is 500×500 pixels. From FIGS. 83-85, the resolution decreases as the distance between two cameras increases. To compensate this effect, a reference camera with higher resolution may be used, but such approach comes with a larger volume of data. Accordingly, the quality of reconstructed image depends on the shape of the object.

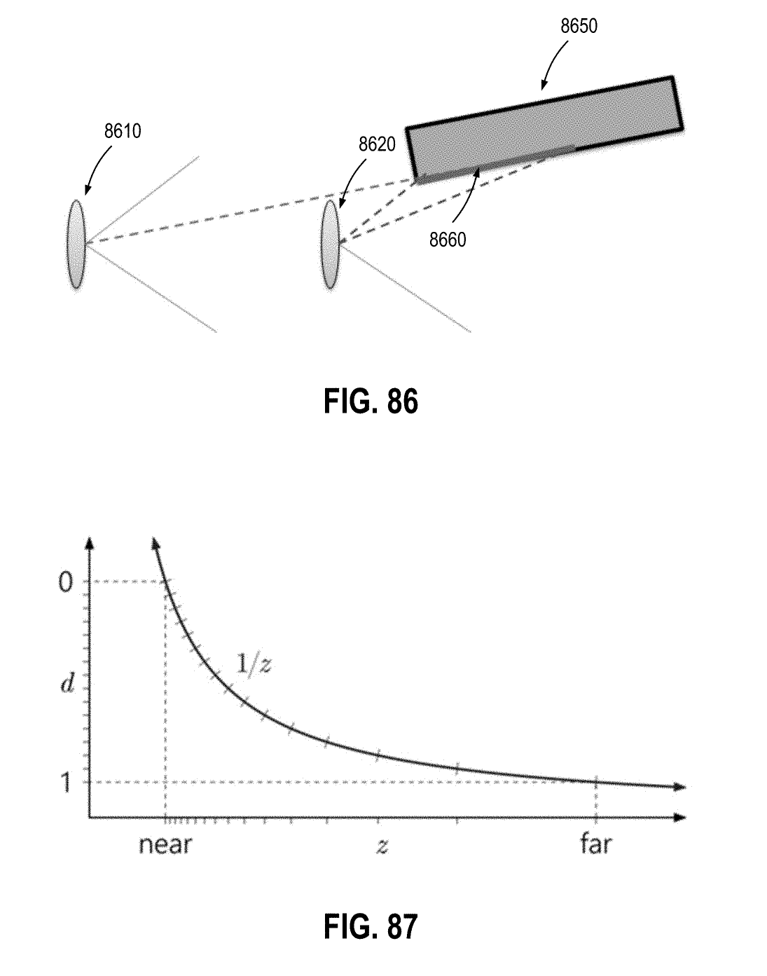

FIG. 86 shows an example of an occlusion area. If camera 8610 is a reference camera, camera 8620 is a rendered camera. Occlusion area 8660 of object 8650 cannot be reconstructed from camera 8610. Based on ray transform rendering, the tilt of the reference face should be less than the intersection angle between rays and the horizontal line. Before using ray transforms, a type of visibility test may be performed to determine any occlusion problems. To solve a detected occlusion problem, the user may shift the reference camera or use additional reference cameras.

For a perspective projection camera, as the camera is positioned farther from an object, the quantization of the depth plane becomes coarser, which means the depth value has a larger error for farther objects.

FIG. 87 is a graph (reproduced from https://developer.nvidia.com/content/depth-precision-visualized) illustrating a relationship between a depth precision and a distance from a camera. It is assumed the reference camera is farther from the object than the synthesized camera. Since the reference camera is farther from the object compared to synthesized camera, the synthesized camera image will be affected by the depth quantization error as well.

4.2 Synthesis Algorithm

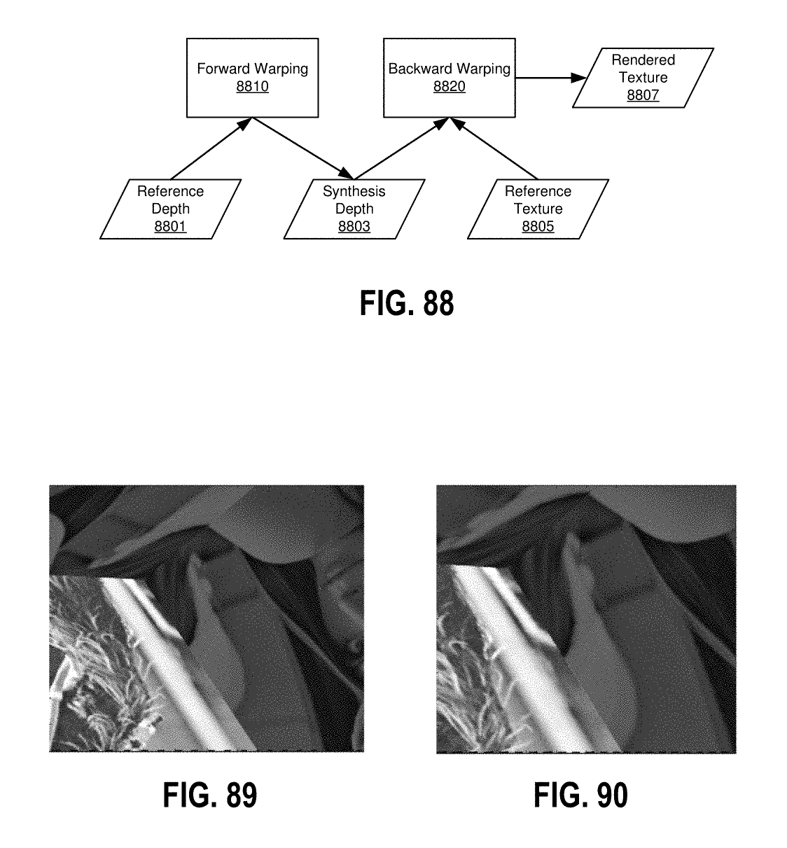

FIG. 88 is a flow diagram of a method for synthesizing a light field image according to one embodiment of the invention. In some embodiments, the method may be performed by rendering unit 1020 of FIG. 10.

In block 8810, forward warping is performed for input reference depth 8801, which generates a synthesis depth map (or warped depth map) 8803 having depth values of the light field image. In one embodiment, the synthesis depth map 8803 may include gaps. For example, referring back to FIGS. 83-85, since the resolution (size) of the reference image and the synthesized image are the same (but the synthesized image is a subset of the reference image), gaps (e.g., black gaps) may appear in the synthesized image after ray transform rendering.

In one embodiment, by applying a gap filling filter on the depth map 8803, the gaps may be filled, for example by neighboring pixels, and a filtered depth map is generated. For example, the shape of an object is usually continuous. Based on this assumption, interpolation may be performed to fill the gaps on the depth map 8803.

At block 8820, backward warping is performed, by using depth map 8803 (or the filtered depth map) and reference texture 8805 to generate rendered texture 8807. For instance, backward warping may be used to find corresponding pixels on the reference image (or texture). The results (or a rendered texture) of backward warping algorithm are shown, for example, in FIGS. 89-90.

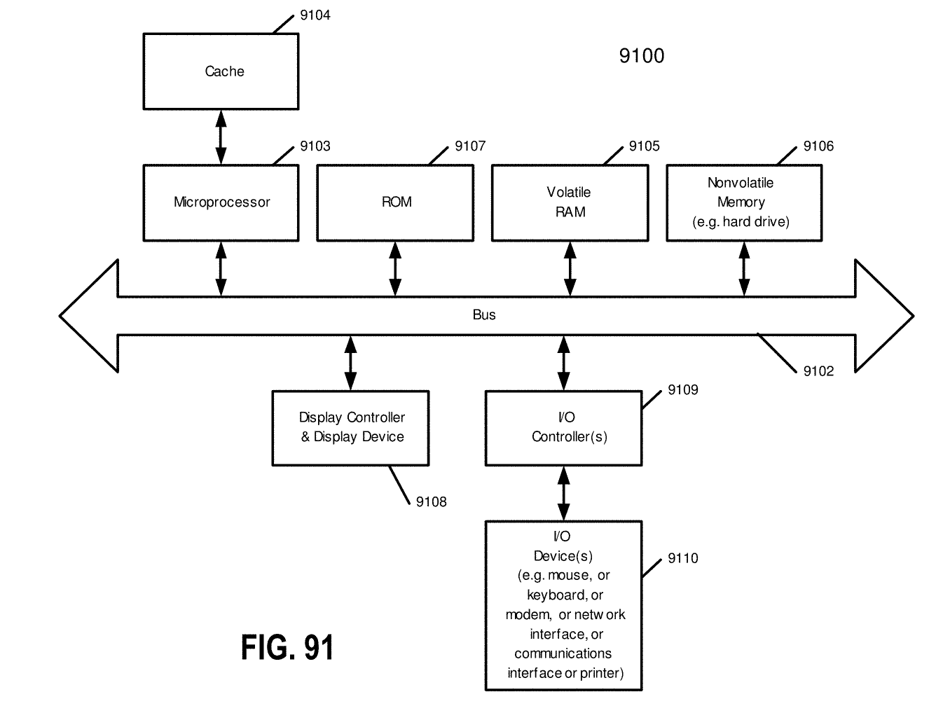

FIG. 91 is a block diagram of a data processing system, which may be used with one embodiment of the invention. For example, the system 9100 may be used as part of the light field imaging system 1000 as shown in FIG. 10. Note that while FIG. 91 illustrates various components of a computer system, it is not intended to represent any particular architecture or manner of interconnecting the components; as such details are not germane to the invention. It will also be appreciated that network computers, handheld computers, mobile devices (e.g., smartphones, tablets) and other data processing systems which have fewer components or perhaps more components may also be used with the invention.

As shown in FIG. 91, the system 9100, which is a form of a data processing system, includes a bus or interconnect 9102 which is coupled to one or more microprocessors 9103 and a ROM 9107, a volatile RAM 9105, and a non-volatile memory 9106. The microprocessor 9103 is coupled to cache memory 9104. The bus 9102 interconnects these various components together and also interconnects these components 9103, 9107, 9105, and 9106 to a display controller and display device 9108, as well as to input/output (I/O) devices 9110, which may be mice, keyboards, modems, network interfaces, printers, and other devices which are well-known in the art.

Typically, the input/output devices 9110 are coupled to the system through input/output controllers 9109. The volatile RAM 9105 is typically implemented as dynamic RAM (DRAM) which requires power continuously in order to refresh or maintain the data in the memory. The non-volatile memory 9106 is typically a magnetic hard drive, a magnetic optical drive, an optical drive, or a DVD RAM or other type of memory system which maintains data even after power is removed from the system. Typically, the non-volatile memory will also be a random access memory, although this is not required.

While FIG. 91 shows that the non-volatile memory is a local device coupled directly to the rest of the components in the data processing system, a non-volatile memory that is remote from the system may be utilized, such as, a network storage device which is coupled to the data processing system through a network interface such as a modem or Ethernet interface. The bus 9102 may include one or more buses connected to each other through various bridges, controllers, and/or adapters, as is well-known in the art. In one embodiment, the I/O controller 9109 includes a Universal Serial Bus (USB) adapter for controlling USB peripherals. Alternatively, I/O controller 9109 may include an IEEE-1394 adapter, also known as FireWire adapter, for controlling FireWire devices.

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method of rendering an image for a light field imaging system, the method comprising:
receiving image data of a light field image of a scene, wherein the light field image comprises one or more subimages;
producing the light field image on a display surface of a display device based on the received image data;
calibrating the display surface based on display calibration parameters; and
generating a new light field image on the calibrated display surface based on a rendering area for each of the subimages.

2. The method of claim 1, wherein calibrating the display surface comprises rotating the display surface by a tilt angle, and shifting the display surface by a fraction of the display surface.

3. The method of claim 2, further comprising determining the rendering area for each of the subimages by determining a new center of display for each of the subimages.

4. The method of claim 1, wherein the display calibration parameters include a horizontal displacement, a vertical displacement, and a tilt angle about a z-axis.

5. The method of claim 1, wherein the subimages are elemental images or hogel images.

6. The method of claim 1, wherein generating the new light field image on the calibrated display surface is performed using multiple-reference depth image-based rendering (MR-DIBR).

7. The method of claim 3, wherein the new center of display for each of the subimages is determined based on the display calibration parameters.

8. The method of claim 3, wherein the new center of display for each of the subimages is a center of a hogel of a hogel array.

9. The method of claim 1, wherein the display surface includes a micro-lens array.

10. The method of claim 1, wherein the light field image is a reference light field image.

11. The method of claim 2, wherein the tilt angle is at most 1°.

12. A computer-implemented method of rendering an image for a light field imaging system, the method comprising:
generating a merged orthographic light field image from a plurality of orthographic light field images;
for each of the orthographic light field images, determining a distance between the orthographic light field image and a further orthographic light field image thereby producing a plurality of distances; and
arranging the orthographic light field images based on the determined distances.

13. The method of claim 12, wherein arranging the orthographic light field images comprises for each of the orthographic light field images, beginning with a shortest distance to a furthest distance, switching the orthographic light field image with a next orthographic light field image if a difference between a candidate depth and a current depth is at least a predetermined depth threshold so as to replace the current depth and a color map of the merged orthographic light field image, and filling a plurality of cracks within the merged orthographic light field image.

14. The method of claim 12, wherein the orthographic light field images include a central view image and extreme view images.

15. The method of claim 12, further comprising determining a number of the orthographic light field images required to generate the merged orthographic light field image.

16. The method of claim 15, further comprising determining whether to generate an additional orthographic light field image based on a distance between a pair of the orthographic light field images; and generating the additional orthographic light field image if the distance is greater than a width of a central view of a central light field camera.

17. The method of claim 15, wherein the number of the orthographic light field images is determined based on a width of a display screen, a depth of an object in the scene, and a field of view (FOV) of a light field camera.

18. The method of claim 14, wherein the orthographic light field images further include four-corner view images to minimize an occlusion area of an object within the scene.

19. The method of claim 16, wherein the distance is computed based on the number of the orthographic light field images and a number of hogels in a hogel array.

20. The method of claim 12, wherein arranging the orthographic light field images includes arranging the orthographic light field images from a shortest distance to a target position to a furthest distance to the target position.

21. The method of claim 16, wherein a viewing angle of a light field camera used to generate the additional orthographic light field image is determined based on a distance between an object and the light field camera, and size of an occlusion area of the object.

22. The method of claim 13, wherein filling the plurality of cracks within the merged orthographic light field image is performed using an inpainting algorithm.

23. The method of claim 12, wherein the plurality orthographic light field images are reference light field images.

24. A computer-implemented method of rendering an image for a light field imaging system, the method comprising:
receiving image data of a light field image that includes a plurality of subimages;
generating a disparity map for the light field image based on the image data by applying a stereo matching algorithm to a pair of subimages of the plurality of subimages;
verifying the disparity map using other subimages from the plurality of subimages; and
converting the disparity map to a depth map for the light field image.

25. The method of claim 24, wherein verifying the disparity map comprises performing a search algorithm to obtain matching blocks between the pair of subimages.

26. The method of claim 25, wherein the search algorithm is a power-of-2, bi-directional search algorithm.

27. The method of claim 24, wherein the pair of subimages are adjacent subimages.

28. The method of claim 25, wherein the disparity map includes a plurality of disparity values, each of the disparity values being computed based on a right disparity value and a left disparity value.

29. The method of claim 28, wherein each of the disparity values is further computed based on a right elemental image distance and a left elemental image distance.

30. The method of claim 24, wherein the pair of subimages is on a same row within the light field image.

31. The method of claim 24, wherein the pair of subimages is on a same column within the light field image.

32. A computer-implemented method of rendering an image for a light field imaging system, the method comprising:
receiving image data of a light field image of a scene, wherein the scene includes one or more objects;
dividing the scene into one or more subspaces based on a depth distribution; and
for each of the subspaces, computing one or more bounding boxes, wherein each of the bounding boxes surrounds an object within the subspace.

33. A computer-implemented method of rendering an image for a light field imaging system, the method comprising:
receiving image data of a light field image of a scene, wherein the scene includes one or more objects; and
for each of the objects,
computing a boundary of the object in the scene, and
calculating a bounding box for the object based on the computed boundary.

34. The method of claim 33, wherein computing the boundary of the object is performed using a gradient map.

35. A computer-implemented method of rendering an image for a light field imaging system, the method comprising:
receiving image data of a light field image of a scene, wherein the scene includes one or more objects; and
for each of the objects,
searching a neighboring pixel to determine a boundary of the object, and
calculating a bounding box for the object based on the determined boundary.

36. The method of claim 35, wherein the bounding box for each object includes a view of the object.

37. The method of claim 36, further comprising combining the bounding boxes for the objects to reduce occlusion.

38. The method of claim 36, wherein the view is a right view, a left view, a top view, or a bottom view of the object.

39. A computer-implemented method of rendering an image for a light field imaging system, the method comprising:
generating a synthesized light field image that includes a plurality of gaps;
forward warping a reference depth of the synthesized light field image to produce a synthesis depth map;
applying a gap filling filter on the synthesis depth map; and
backward warping the synthesize depth map based on a reference texture to produce a rendered texture of the synthesized light field image.

40. The method of claim 39, wherein the gaps are eliminated from the rendered texture of the synthesized light field image.

41. The method of claim 39, wherein the synthesized light field image is generated using ray transform-based rendering.

42. A light field imaging system comprising:
a processor; and
a memory coupled to the processor to store instructions, which when executed by the processor, cause the processor to perform operations, the operations comprising:
receiving image data of a light field image of a scene, wherein the light field image comprises one or more subimages;
producing the light field image on a display surface of a display device based on the received image data;
calibrating the display surface based on display calibration parameters; and
generating a new light field image on the calibrated display surface based on a rendering area for each of the subimages.

43. The light field imaging system of claim 42 wherein calibrating the display surface comprises rotating the display surface by a tilt angle, and shifting the display surface by a fraction of the display surface.

44. The light field imaging system of claim 43, wherein the operations further comprise determining the rendering area for each of the subimages by determining a new center of display for each of the subimages.

45. The light field imaging system of claim 42, wherein the display calibration parameters include a horizontal displacement, a vertical displacement, and a tilt angle about a z-axis.

46. The light field imaging system of claim 42, wherein the subimages are elemental images or hogel images.

47. The light field imaging system of claim 42, wherein generating the new light field image on the calibrated display surface is performed using multiple-reference depth image-based rendering (MR-DIBR).

48. The light field imaging system of claim 44, wherein the new center of display for each of the subimages is determined based on the display calibration parameters.

49. The light field imaging system of claim 44, wherein the new center of display for each of the subimages is a center of a hogel of a hogel array.

50. The light field imaging system of claim 42, wherein the display surface includes a micro-lens array.

51. The light field imaging system of claim 42, wherein the light field image is a reference light field image.

52. The light field imaging system of claim 43, wherein the tilt angle is at most 1°.

53. A light field imaging system comprising:
a processor; and
a memory coupled to the processor to store instructions, which when executed by the processor, cause the processor to perform operations, the operations comprising:
generating a merged orthographic light field image from a plurality of orthographic light field images;
for each of the orthographic light field images, determining a distance between the orthographic light field image and a further orthographic light field image thereby producing a plurality of distances; and
arranging the orthographic light field images based on the determined distances.

54. The light field imaging system of claim 53, wherein arranging the orthographic light field images comprises for each of the orthographic light field images, beginning with a shortest distance to a furthest distance, switching the orthographic light field image with a next orthographic light field image if a difference between a candidate depth and a current depth is at least a predetermined depth threshold so as to replace the current depth and a color map of the merged orthographic light field image, and filling a plurality of cracks within the merged orthographic light field image.

55. The light field imaging system of claim 53, wherein the orthographic light field images include a central view image and extreme view images.

56. The light field imaging system of claim 53, wherein the operations further comprise determining a number of the orthographic light field images required to generate the merged orthographic light field image.

57. The light field imaging system of claim 56, wherein the operations further comprise determining whether to generate an additional orthographic light field image based on a distance between a pair of the orthographic light field images; and generating the additional orthographic light field image if the distance is greater than a width of a central view of a central light field camera.

58. The light field imaging system of claim 56, wherein the number of the orthographic light field images is determined based on a width of a display screen, a depth of an object in the scene, and a field of view (FOV) of a light field camera.

59. The light field imaging system of claim 55, wherein the orthographic light field images further include four-corner view images to minimize an occlusion area of an object within the scene.

60. The light field imaging system of claim 57, wherein the distance is computed based on the number of the orthographic light field images and a number of hogels in a hogel array.

61. The light field imaging system of claim 53, wherein arranging the orthographic light field images includes arranging the orthographic light field images from a shortest distance to a target position to a furthest distance to the target position.

62. The light field imaging system of claim 57, wherein a viewing angle of a light field camera used to generate the additional orthographic light field image is determined based on a distance between an object and the light field camera, and size of an occlusion area of the object.

63. The light field imaging system of claim 54, wherein filling the plurality of cracks within the merged orthographic light field image is performed using an inpainting algorithm.

64. The light field imaging system of claim 53, wherein the plurality orthographic light field images are reference images.

65. A light field imaging system comprising:
a processor; and
a memory coupled to the processor to store instructions, which when executed by the processor, cause the processor to perform operations, the operations comprising:
receiving image data of a light field image that includes a plurality of subimages;
generating a disparity map for the light field image based on the image data by applying a stereo matching algorithm to a pair of subimages of the plurality of subimages;
verifying the disparity map using other subimages from the plurality of subimages; and
converting the disparity map to a depth map for the light field image.

66. The light field imaging system of claim 65, wherein verifying the disparity map comprises performing a search algorithm to obtain matching blocks between the pair of subimages.

67. The light field imaging system of claim 66, wherein the search algorithm is a power-of-2, bi-directional search algorithm.

68. The light field imaging system of claim 65, wherein the pair of subimages are adjacent subimages.

69. The light field imaging system of claim 66, wherein the disparity map includes a plurality of disparity values, each of the disparity values is computed based on a right disparity value and a left disparity value.

70. The light field imaging system of claim 69, wherein each of the disparity values is further computed based on a right elemental image distance and a left elemental image distance.

71. The light field imaging system of claim 65, wherein the pair of subimages is on a same row of the light field image.

72. The light field imaging system of claim 65, wherein the pair of subimages is on a same column of the light field image.

73. A light field imaging system comprising:
a processor; and
a memory coupled to the processor to store instructions, which when executed by the processor, cause the processor to perform operations, the operations comprising:
receiving image data of a light field image of a scene, wherein the scene includes one or more objects;
dividing the scene into one or more subspaces based on a depth distribution; and
for each of the subspaces, computing one or more bounding boxes, wherein each of the bounding boxes surrounds an object within the subspace.

74. A light field imaging system comprising:
a processor; and
a memory coupled to the processor to store instructions, which when executed by the processor, cause the processor to perform operations, the operations comprising:
receiving image data of a light field image of a scene, wherein the scene includes one or more objects; and
for each of the objects,
computing a boundary of the object in the scene, and
calculating a bounding box for the object based on the computed boundary.

75. The light field imaging system of claim 74, wherein computing the boundary of the object is performed using a gradient map.

76. A light field imaging system comprising:
a processor; and
a memory coupled to the processor to store instructions, which when executed by the processor, cause the processor to perform operations, the operations comprising:
receiving image data of a light field image of a scene, wherein the scene includes one or more objects; and
for each of the objects,
searching a neighboring pixel to determine a boundary of the object, and
calculating a bounding box for the object based on the determined boundary.

77. The light field imaging system of claim 76, wherein the bounding box for each object includes a view of the object.

78. The light field imaging system of claim 77, wherein the operations further comprise combining the bounding boxes for the objects to reduce occlusion.

79. The light field imaging system of claim 77, wherein the view is a right view, a left view, a top view, or a bottom view of the object.

80. A light field imaging system comprising:
a processor; and
a memory coupled to the processor to store instructions, which when executed by the processor, cause the processor to perform operations, the operations comprising:
generating a synthesized light field image that includes a plurality of gaps;
forward warping a reference depth of the synthesized light field image to produce a synthesis depth map;
applying a gap filling filter on the synthesis depth map; and
backward warping the synthesize depth map based on a reference texture to produce a rendered texture of the synthesized light field image.

81. The light field imaging system of claim 80, wherein the gaps are eliminated from the rendered texture of the synthesized light field image.

82. The light field imaging system of claim 80, wherein the synthesized light field image is generated using ray transform-based rendering.
